(19) United States
(12) Patent Application Publication
(10) Pub. No.: US 2009/0079676 A1
(43) Pub. Date: Mar. 26, 2009

(54) DISPLAY APPARATUS AND DRIVE METHOD THEREOF

(75) Inventors: Tomoyuki SHIRASAKI, Tokyo (JP); Satoru Shimoda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/211,929

(22) Filed: Sep. 17, 2008

(30) Foreign Application Priority Data
Sep. 20, 2007 (JP) 2007-243775

(51) Int. Cl. G09G 3/30; G09G 3/20

(52) U.S. Cl. 345/76; 345/55

(57) ABSTRACT

A display apparatus comprises a display section including a display panel having a plurality of arranged display pixels, a display state of each of the display pixels being changed by an electric field generated between a pair of electrodes arranged to be opposed to each other; a luminous section including a luminous panel having a plurality of luminous pixels arranged correspondingly to each of the plurality of display pixels; and a control section for controlling the display state of one of the display pixels in the display panel by making an arbitrary one of the luminous pixels in the luminous panel emit a light.

### BACKGROUND OF THE INVENTION

1. Field of the Invention

The present invention relates to a display apparatus and a drive method thereof, and more particularly to a display apparatus capable of being applied to the so-called electric paper, which can fixedly hold its display state without consume any electric power, and a drive method thereof.

2. Related Art

In recent years, the research and the development of a display device called as electric paper have been actively performed to be an information transmission medium as a substitute for paper media such as newspapers and books. The electric paper has the following features: being rewritable of character information and image information; having high visibility; being light and thin-shaped; being rich in flexibility; and not needing any electric power at the time of displaying except for the time of writing character information or image information.

Here, for example, the following display devices are known as those to be applied into the electric paper: a display device of an electrophoretic system, which includes charged particles as display media in a solvent to move the charged particles in the solvent by applying an electric field according to display data; and a display device of a toner system, which seals toner (charged particles) as a display medium in the spaces (unit cells) formed between substrates without using any toner solvents and moves the toner by applying an electric field according to display data.

Incidentally, the electric paper to which the electrophoretic system is applied is minutely described in, for example, Japanese Patent Application Laid-Open Publication No. 2003-161822.

However, since the output voltage necessary at the time of writing image information including character information (hereinafter abbreviated to as “image information”) Into the related art electric paper is very high (for example, about 50 V) in comparison with that of a liquid crystal display device and the like, the related art electric paper has a problem of being obliged to use dedicated display drivers that can bear the high potential difference (that is, high withstand voltage ones) and display switching elements for applying the high potential difference output voltages to display electrodes.

Accordingly, in view of the aforesaid problem, it is an object of the present invention to provide a display apparatus that can be applied to electric paper and can be securely write and display desired image information well without using any dedicated drivers and switching elements that can bear the high potential difference, and a drive method thereof.

### SUMMARY OF THE INVENTION

According to an aspect of the present invention, a display apparatus comprises: a display section including a display panel having a plurality of arranged display pixels, a display state of each of the display pixels being changed by an electric field generated between a pair of electrodes arranged to be opposed to each other; a luminous section including a luminous panel having a plurality of luminous pixels arranged correspondingly to each of the plurality of display pixels; and a control section for controlling the display state of one of the display pixels in the display panel by making an arbitrary one of the luminous pixels in the luminous panel emit a light.

The display panel may include electrifiable particles having charging characteristics of different polarities and different colors, the particles put between the pair of electrodes to be sealed therein, in the display apparatus.

Moreover, the display panel may include electrifiable particles having charging characteristics of different polarities and different colors, the particles put between the pair of electrodes to be sealed therein, and the display panel may further include a partition wall to partition a space in which the electrifiable particles are sealed by each of the display pixels, in the display apparatus.

Moreover, the pair of electrodes may include a first electrode and a second electrode, and the first electrode of the display panel may be coated by a photoconductive layer, in the display apparatus.

Moreover, each of the pair of electrodes may be composed of a single electrode layer common to the plurality of display pixels, in the display apparatus.

Moreover, the pair of electrodes may include a first electrode and a second electrode, and the display section may further include an application voltage setting section to apply a predetermined reference voltage to the second electrode, and to apply a voltage of being either of relatively positive electric potential and negative electric potential to the reference voltage to the first electrode, in the display apparatus.

Moreover, the luminous panel may include light blocking bodies to block lights emitted from the luminous pixels in boundary areas between any twos of the display pixels, in the display apparatus.

Moreover, the pair of electrodes may include a first electrode and a second electrode; the first electrode may include a pair of electrode layers divided by each of the display pixels; the second electrode may be composed of a single electrode layer common to the plurality of display pixels; and the luminous pixels may be arranged correspondingly to each of the electrode layers in the luminous panel, in the display apparatus.

Moreover, the pair of electrodes may include a first electrode and a second electrode; and

the display section may include an application voltage setting section to apply a predetermined reference voltage to the second electrode, to apply a voltage of being relatively positive electric potential to the reference voltage to one electrode layer of the first electrode, and to apply a voltage of being relatively negative electric potential to the reference voltage to another electrode layer of the first electrode, in the display apparatus.

Moreover, the plurality of luminous pixels may be two-dimensionally arranged in the luminous panel, each of the luminous pixels including an organic electroluminescence element having a top emission type luminous structure, in the display apparatus.

Moreover, a drive method of a display apparatus comprising a display section including a display panel having a plurality of arranged display pixels, a display state of each of the display pixels being changed by an electric field generated between a pair of electrodes to include a first electrode and a second electrode arranged to be opposed to each other, and a luminous section including a luminous panel having a plurality of luminous pixels arranged correspondingly to each of the plurality of display pixels, comprises the step of: making an arbitrary one of the luminous pixels in the luminous panel emit a light; generating the electric field between the first electrode and the second electrode of the display panel; and controlling the display state of one of the display pixels to display desired image information.

The step of generating the electric field between the first electrode and the second electrode of the drive method of a display apparatus may be performed by making an arbitrary one of the luminous pixels in the luminous panel emit a light in a state of applying a predetermined reference voltage to the second electrode and applying a voltage of being either of relatively positive electric potential and negative electric potential to the reference voltage to the first electrode.

The drive method of a display apparatus may further comprise the steps of: executing a reset operation to set all the display pixels in a first display state by making all the luminous pixels in the luminous panel emit lights in a state of applying a predetermined reference voltage to the second electrode and applying a first voltage of being either of relatively positive electric potential and negative electric potential to the reference voltage to the first electrode; and executing a display writing operation to set an arbitrary one of the display pixels in a second display state by making an arbitrary one of the luminous pixels in the luminous panel emit a light in a state of applying the reference voltage to the second electrode and applying a second voltage of being either of the negative electric potential and the positive electric potential to the reference voltage to the first electrode.

The drive method of a display apparatus may further comprise the step of executing a charge separating operation to charge electrifiable particles having different colors, the particles sealed between the first electrode and the second electrode of the display panel, by generating an alternating electric field between the first electrode and the second electrode by making all the luminous pixels in the luminous panel emit lights in a state of applying the reference voltage to the second electrode and applying an alternating voltage of periodically changing to be the positive electric potential and the negative electric potential to the reference voltage to the first electrode, prior to either of the reset operation and the display writing operation.

### BRIEF DESCRIPTION OF THE DRAWINGS

The present invention will sufficiently be understood by the following detailed description and accompanying drawings, but they are provided for illustration only, and not for limiting the scope of the invention, in which:

FIG. 1A is a schematic configuration diagram showing the whole configuration of a display apparatus of an embodiment to which the present invention is applied;

FIG. 1B is a schematic configuration diagram showing the whole configuration of the display apparatus of the embodiment to which the present invention is applied;

FIG. 2A is a block diagram showing the schematic configuration of a display section and luminous section applied to the display apparatus of the embodiment to which the present invention is applied;

FIG. 2B is another block diagram showing the schematic configuration of the display section and the luminous section applied to the display apparatus of the embodiment to which the present invention is applied;

FIG. 3 is a principal part sectional view showing a first embodiment of a device structure of the display apparatus of the embodiment to which the present invention is applied;

FIG. 4A is a schematic diagram showing the principle of operation of the display apparatus of the embodiment to which the present invention is applied;

FIG. 4B is a schematic diagram showing the principle of operation of the display apparatus of the embodiment of the present invention;

FIG. 5A is a characteristic diagram showing the luminous spectral characteristic of a luminous element that can be applied to an array substrate according to a first embodiment;

FIG. 5B is a characteristic diagram showing the spectral sensitivity characteristic of a photoconductive layer that can be applied to a display panel;

FIG. 6 is a schematic diagram showing an example of the circuit configuration of a luminous pixel to be applied to a display apparatus according to a first embodiment;

FIG. 7 is a timing chart showing an example of a normally white display drive operation (drive method) of the display apparatus according to the first embodiment;

FIG. 8 is a schematic state diagram showing a charge separating operation in the display drive operation according to the first embodiment;

FIG. 9 is a schematic state diagram showing a white resetting operation in the display drive operation according to the first embodiment;

FIG. 10 is a schematic state diagram showing a black display writing operation in the display drive operation according to the first embodiment;

FIG. 11 is a schematic state diagram showing a display holding operation in the display drive operation according to the first embodiment;

FIG. 12 is a principal part sectional view showing the device structure of a display apparatus according to a second embodiment;

FIG. 13 is a timing chart showing an example of a display drive operation (drive method) of the display apparatus according to the second embodiment;

FIG. 14 is a schematic state diagram showing a charge separating operation in the display drive operation according to the second embodiment;

FIG. 15 is a schematic state diagram showing a black display writing operation in the display drive operation of the second embodiment;

FIG. 16 is a schematic state diagram showing a white display writing operation in the display drive operation according to the second embodiment;

FIG. 17 is a schematic state diagram showing a display holding operation in the display drive operation according to the second embodiment;

FIG. 18 is a schematic state diagram showing a white resetting operation in the display drive operation according to the second embodiment;

FIG. 19 is a principal part sectional view showing the device structure of a display apparatus according to a third embodiment;

FIG. 20A is a conceptual diagram for illustrating a display failure owing to crosstalk arising between adjacent display pixels;

FIG. 20B is a conceptual diagram for illustrating a display failure owing to crosstalk arising between adjacent display pixels;

FIG. 21A is a principal part configuration diagram showing a display apparatus according to a fourth embodiment;

FIG. 21B is another principal part configuration diagram of the display apparatus according the fourth embodiment; and

FIG. 22 is a schematic state diagram showing an example of a color display writing operation in a display drive operation according to the fourth embodiment.

### DETAILED DESCRIPTION OF THE PREFERRED EMBODIMENTS

In the following, a display apparatus and a drive method thereof that are embodiments of the present invention will be minutely described.

### (Whole Configuration of Display Apparatus)

First the whole configuration of a display apparatus according to an embodiment of the present invention will be described.

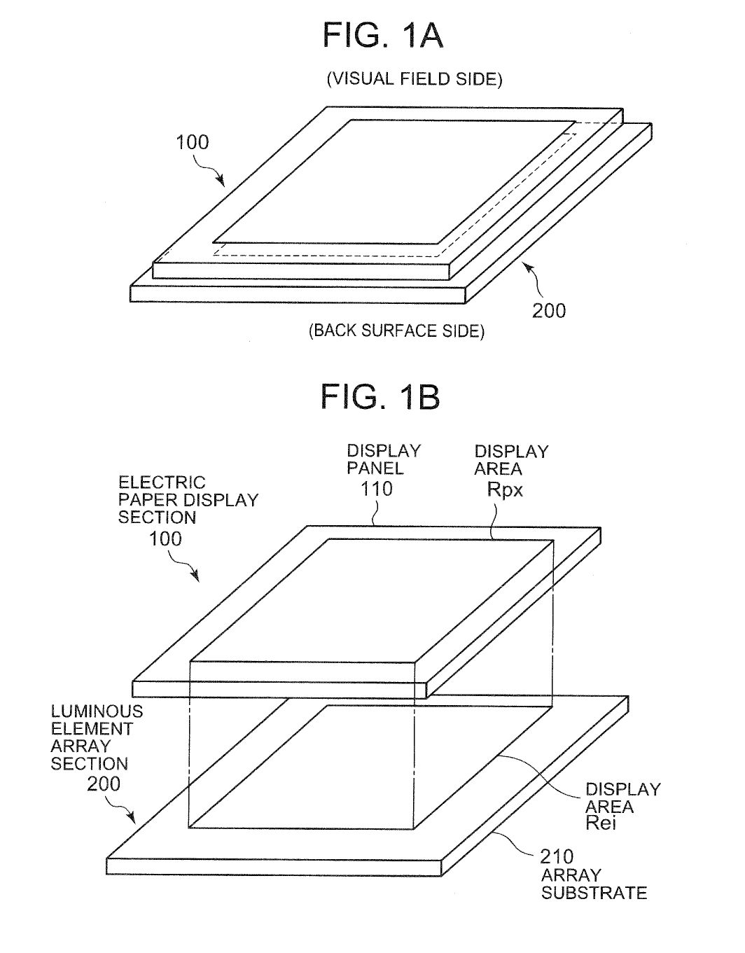

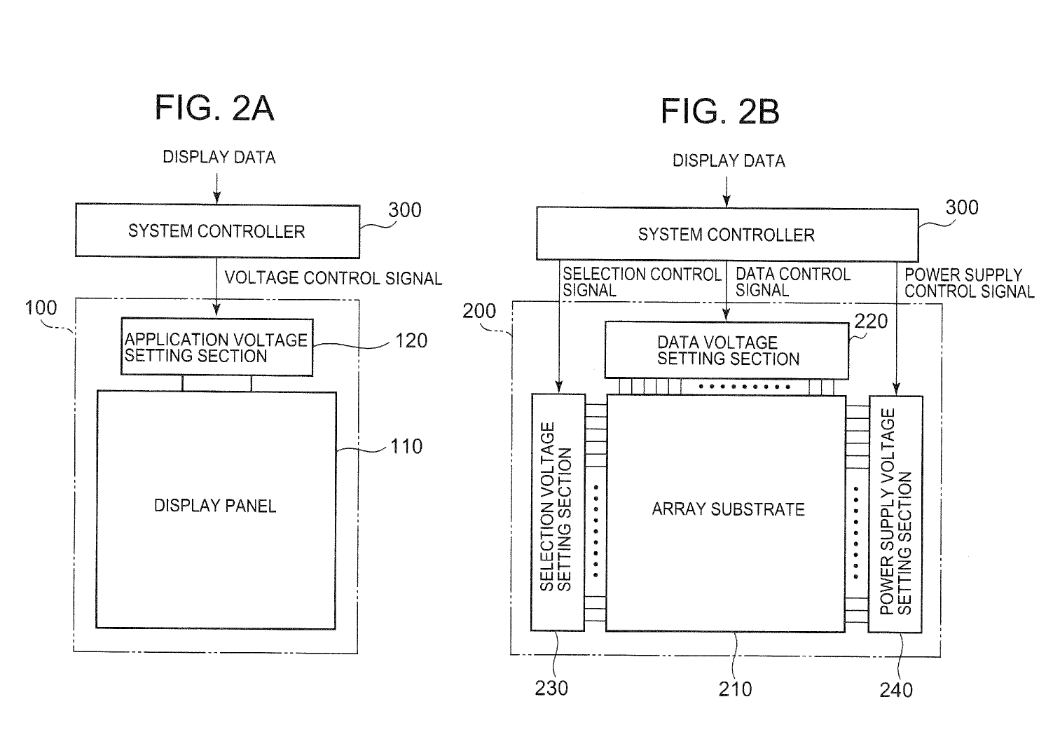

FIGS. 1A and 1B are schematic configuration diagrams showing the whole configuration of the display apparatus. Here FIG. 1A is a perspective view showing the schematic configuration of the display apparatus, and FIG. 1B is a conceptual diagram for illustrating the laminated structure of the display apparatus. FIGS. 2A and 2B are block diagrams showing the schematic configurations of a display section and a luminous section that are applied to the display apparatus. FIG. 2A is a schematic configuration diagram of the electric paper display section that can be applied to the display apparatus, FIG. 2B is a schematic configuration diagram of the luminous element array section that can be applied to the display apparatus.

The components of the display apparatus according to the embodiment of the present invention are roughly classified to an electric paper display section (display section) 100 on the upper layer side (the upper side in the drawing), which is a visual field side, a luminous element array section (luminous section) 200 on the lower layer side (the lower side in the drawing), which is a back surface side, and a system controller (control section) 300, as shown in FIGS. 1A, 2A, and 2B. As shown in FIG. 1B, a display area Rpx of the electric paper display section 100 and a luminous area Rel of the luminous element array section 200 are formed by being arranged to be overlapped with each other in a plane to accord with each other or to substantially accord with each other. The electric paper display section 100 and formed in a panel structure in which the under surface of the electric paper display section 100 and the top surface of the luminous element array section 200 are, for example, pasted (joined) together to adhere closely to each other.

As shown in FIG. 2A, the electric paper display section 100 has the so-called electric paper type panel structure schematically. The electric paper display section 100 includes a display panel 110 (the details of which will be described later) on which the display area Rpx is set and an application voltage setting section 120, which is formed to be opposed to an area including at least the display area Rpx, to apply a predetermined voltage to a pair of electrodes (upper electrode and lower electrode) of the electric paper. The electric paper display section 100 controls a voltage to be applied from the application voltage setting section 120 to each electrode of the display panel 110 and the application timing of the voltage on the basis of, for example, a voltage control signal from a system controller 300 provided on the outside of the electric paper display section 100, and thereby the electric paper display section displays desired image information (including character information) according to display data in the display area Rpx.

The luminous element array section 200, as shown in FIG. 2B, includes an array substrate (luminous panel) 210 including the set luminous area Rel, in which a plurality of luminous elements (or luminous pixels) is two-dimensionally arranged in row directions and column directions so as to correspond to the display area Rpx of the electric paper display section 100 shown in FIG. 1B, or a schematic diagram, as well as a data voltage setting section 220, a selection voltage setting section 230, and a power supply voltage setting section 240 to apply a data voltage, a selection voltage, and a power supply voltage, respectively, for driving and controlling the luminousness of each luminous element in the luminous area Rel. The luminous element array section 200 controls each of the voltages to be applied from the data voltage setting section 220, the selection voltage setting section 230, and the power supply voltage setting section 240 to each luminous element on the array substrate 210 on the basis of, for example, a data control signal, a selection control signal, and a power supply control signal from the system controller 300 provided on the outside of the luminous element array section 200, and the application timing of the voltages to perform the luminous operation or the nonluminous operation of each luminous element according to the display data (or image information).

The system controller 300 generates a voltage control signal to control the operation of applying the predetermined voltage to each electrode of the display panel 110 at predetermined timing or the operation of blocking the application of the voltage on the basis of, for example, the display data input from the outside of the display apparatus (the electric paper display section 100 and the luminous element array section 200), and output the generated voltage to the application voltage setting section 120. Incidentally, the system controller 300 may be solely provided as a common component to the electric paper display section 100 and luminous element array section 200 shown in FIGS. 2A 2B, or may be severally provided as an individual component to each of the electric paper display section 100 and the luminous element array section 200.

### First Embodiment

### (Device Structure of Display Apparatus)

Next the device structure of the display apparatus according to the embodiment of the present invention will be described.

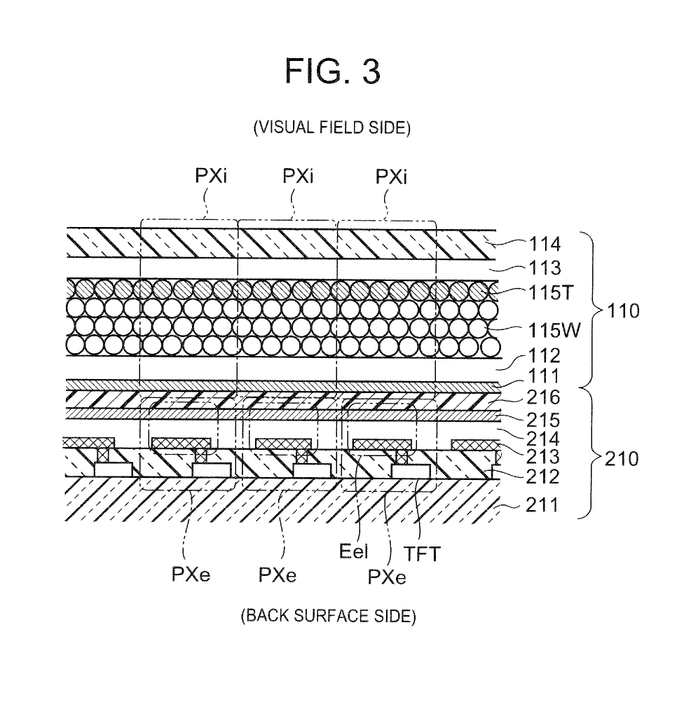

FIG. 3 is a principal part sectional view showing a first embodiment of the device structure of the display apparatus according to the embodiment of the present invention. Here FIG. 3 is a sectional view at the same position as those of the display panel 110 and the array substrate 210 shown in FIGS. 2A and 2B. Incidentally, the showing of a part of hatchings indicating cross sections is omitted for convenience of diagrammatic representation. White particles 115W are colored to be solid, and only black particles 115T are shown to be hatched in order to distinguish the black particles 115T from the white particles 115W.

As shown in FIG. 3, the display panel 110 to be applied to the electric paper display section 100 includes a lower electrode 111 formed of a single transparent electrode (solid electrode) correspondingly to substantially the whole area of the display area Rpx, a photoconductive (PC) layer 112 represented by polyvinylcarbazole (PVK), phthalocyanine, and the like, to be formed to be coated on the lower electrode 111, and an upper electrode 113 formed of a single transparent electrode (solid electrode) correspondingly to substantially the whole area of the display area Rpx to be arranged to be opposed to the photoconductive layer 112 with a predetermined interval by being separated from the photoconductive layer 112. The display panel 110 has a device structure of putting the electrifiable black particles 115T and the white particles 115W (electrifiable particles) into the gap between the photoconductive layer 112 and the upper electrode 113 in the state of being intermixed and dispersed (being sealed between them). Each of the lower electrode 111 and the upper electrode 113 is formed of a transparent electrode material, such as, tin-doped indium oxide (indium tin oxide (ITO)) or zinc-doped indium oxide (indium zinc oxide (IZO)).

A reference voltage V0 of the predetermined voltage value (for example, the ground potential Vgnd) is applied from the application voltage setting section 120 to the upper electrode 113, and a voltage of either of relatively positive electric potential and negative electric potential to the reference voltage V0 is applied from the application voltage setting section 120 to the lower electrode 111. To put it concretely, the application voltage setting section 120 shown in FIG. 2A selectively sets either of the operation of applying the fixed reference voltage V0 (for example, the ground potential Vgnd) to the upper electrode 113 (reference voltage application state) and the operation of blocking the application of the reference voltage V0 to put the upper electrode 113 in an electrically separated state (high impedance state) from the particles 115T and 115W on the basis of a voltage control signal output from the system controller 300. Moreover, the application voltage setting section 120 selectively sets any of the operation of applying either of the voltage (positive voltage) of the positive electric potential and the voltage (negative voltage) of the negative electric potential to the reference voltage V0 (positive and negative voltage application state), the operation of applying an alternating voltage set to repeat the positive and negative voltages at a predetermined period (alternating voltage application state), and the operation of blocking the application of the positive and negative voltages to electrically separate the lower electrode 111 from the photoconductive layer 112 (high impedance state), to the lower electrode 111 on the basis of a voltage control signal output from the system controller 300. Incidentally, the setting of the voltages to be applied to the lower electrode 111 and the upper electrode 113 will be minutely described with regard to a drive method described below.

Moreover, as shown in FIG. 3, the device structure of the array substrate 210 to be applied to the luminous element array section 200 is the one in which luminous pixels PXe including luminous elements Eel, such as organic electroluminescence elements (hereinafter abbreviated to) “organic EL elements”), are arranged in the luminous area Rel set correspondingly to the display area Rpx of the display panel 110. Each of the luminous pixels PXe includes a drive transistor TFT made of a thin film transistor formed on an insulative substrate 211; a pixel electrode 213 formed on an insulation film 212 formed so as to coat the drive transistor TFT, which pixel electrode 213 is connected to the drive transistor TFT and includes an electrode material, such as an aluminum alloy having a light reflection characteristic; a luminous function layer 214 including an organic EL layer formed on the pixel electrode 213; a counter electrode 215, which is formed of a single electrode (solid electrode) common to each of the luminous pixels PXe and includes an electrode material, such as ITO, having a light transmission characteristic; and a transparent insulation film 216 coating the whole area of the display panel 110 (display area Rpx).

Here the drive transistor TFT formed on the substrate 211 may be a transistor forming a part of a luminous drive circuit for supplying a luminous drive current to the pixel electrode 213 of the luminous element Eel (organic EL element), which will be described later. Moreover, the pixel electrode 213, the luminous function layer 214, and the counter electrode 215, which are laminated on the insulation film 212 coating the drive transistor TFT in order, constitute an organic EL element, which is the luminous element Eel. Because the pixel electrode 213 of a lower layer of the luminous function layer 214 has a light reflection characteristic and the counter electrode 215 of an upper layer of the luminous function layer 214 has a light transmission characteristic, the luminous element Eel (organic EL element) has a top emission type luminous structure, in which a light emitted by the luminous function layer 214 is emitted not to the side of the substrate 211, on which the drive transistor TFT is formed, but to the side of the display panel 110 (that is, the visual field side). Then the lower electrode 111 and the photoconductive layer 112 of the display panel 110 are joined so as to adhere closely to the transparent insulation film 216 formed on the uppermost layer of the array substrate 210 including the luminous element Eel as shown in FIG. 3.

### (Principle of Operation of Drive Method)

Next the features of the photoconductive layer 112 applied to the display apparatus according to the embodiment of the present invention and the principle of the operation of the display apparatus will be described with reference to the device structure mentioned above.

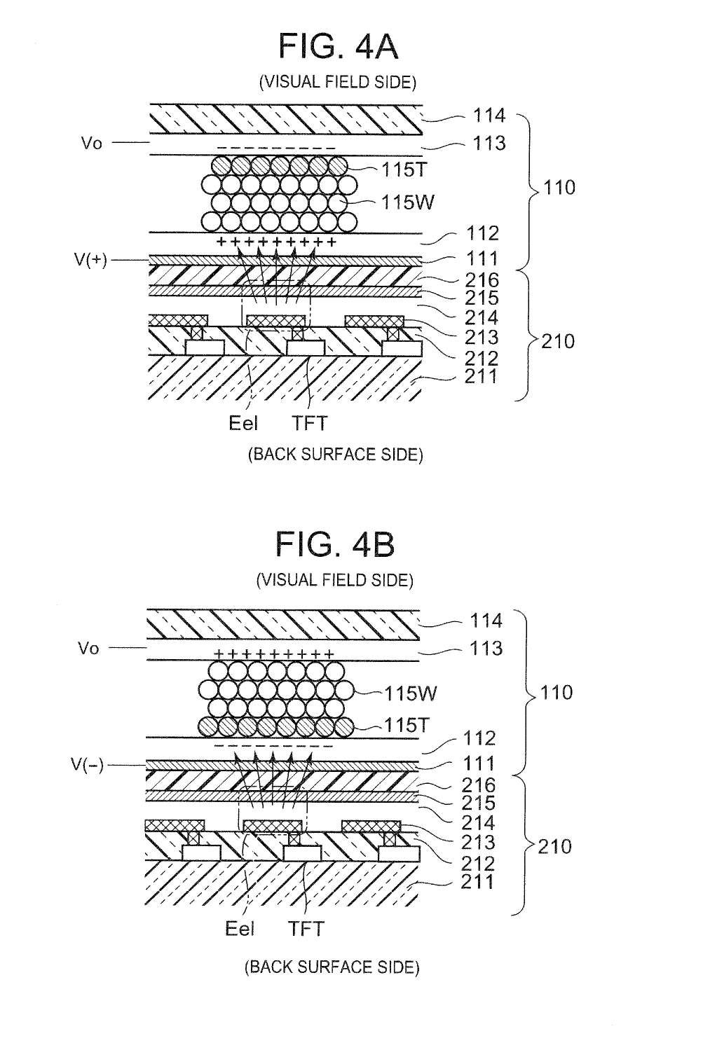

FIGS. 4A and 4B are schematic diagrams showing the principle of the operation of the display apparatus of the embodiment of the present invention. Here FIG. 4A is a schematic diagram showing the principle of a black writing operation, and FIG. 4B is a schematic diagram showing the principle of a white writing operation.

The photoconductive layer 112 applied to the display panel 110 has a characteristic of generating carriers when the photoconductive layer 112 is irradiated by a light including a predetermined wavelength band. In particular, as described above, an arbitrary charged state can be realized on the basis of a relative relationship between the voltage (positive voltage or negative voltage) applied from the application voltage setting section 120 to the lower electrode 111 coated on the photoconductive layer 112 and the reference voltage V0 (=Vgnd) applied from the application voltage setting section 120 to the upper electrode 113.

To put it concretely, as shown in FIG. 4A, a voltage V(+) of a positive voltage to the reference voltage V0 (=Vgnd) applied to the upper electrode 113 is applied to the lower electrode 111. In this state, an excitation light of a predetermined wavelength is radiated from one of the luminous elements Eel formed in the array substrate 210 to the photoconductive layer 112. Thereby an area of the photoconductive layer 112 which is irradiated by the light is changed to a conductive state in the thickness direction. Then, positive charges (+) to produce positive electric potential are generated in the neighborhood of the surface of the photoconductive layer 112 on the side of the upper electrode 113 (the upper side in the drawing), and negative charges (−) corresponding to the positive charges are generated in the neighborhood of the surface of the upper electrode 113 on the side of the lower electrode 111 (the lower side in the drawing). Consequently, the upper electrode 113 functions as a negative electrode and the lower electrode 111 (photoconductive layer 112) functions as a positive electrode. Thus a predetermined electric field (referred to “first electric field” for descriptive purpose) can be generated between the upper electrode 113 and the lower electrode 111.

Thereby the black particles 115T charged to be relatively positive (+) (or easily charged to be positive (+)) move toward the upper electrode 113, which is charged to relatively negative (−), and the white particles 115W charged to negative (−) (or easily charged to negative (−)) move toward the photoconductive layer 112 (the lower electrode 111), which is charged to positive (+), to be driven out to the lower side of the black particles 115T (the side of the photoconductive layer 112), between the black particles 115T and the white particles 115W, which are sealed between the photoconductive layer 112 and the upper electrode 113. Consequently only the black particles 115T can be sighted from the side of the upper electrode 113 (the upper side in the drawing), which is the visual field side, and then a black display can be realized.

Moreover, as shown in FIG. 4B, a voltage V(−) of a negative voltage to the reference voltage V0 (=Vgnd) applied to the upper electrode 113 is applied to the lower electrode 111. In this state, an excitation light of the predetermined wavelength is radiated from one of the luminous elements Eel formed in the array substrate 210 to the photoconductive layer 112. In this case, an area of the photoconductive layer 112 which is irradiated by the light is changed to a conductive state in the thickness direction. Then, negative charges (−) to produce negative electric potential are generated in the neighborhood of the surface of the photoconductive layer 112 on the side of the upper electrode 113 (the upper side in the drawing), and positive charges (+) corresponding to the negative charges are generated in the neighborhood of the surface of the upper electrode 113 on the side of the lower electrode 111 (the lower side in the drawing). Consequently, the upper electrode 113 functions as a positive electrode and the lower electrode 111 (photoconductive layer 112) functions as a negative electrode. Thus a predetermined electric field (referred to “second electric field” for descriptive purpose) reverse to that of the first electric field can be generated between the upper electrode 113 and the lower electrode 111.

Thereby the black particles 115T charged to be relatively positive (+) (or easily charged to be positive (+)) move toward the photoconductive layer 112 (the lower electrode 111), which is charged to relatively negative (−), and the white particles 115W charged to negative (−) (or easily charged to negative (−)) move toward the upper electrode 113, which is charged to positive (+), to be driven out to the upper side of the black particles 115T (the side of the upper electrode 113). Consequently only the white particles 115W can be sighted from the side of the upper electrode 113 (the upper side in the drawing) which is the visual field side, and then a white display can be realized. The white display is realized by the reflection of a light that has entered the display panel 110 from the outside of the display panel 110 by the white particles 115W.

Consequently, in the display panel 110 of the electric paper display section 100, the reference voltage V0 is applied to the upper electrode 113, and an arbitrary voltage (the positive voltage V(+) or the negative voltage V(−) to the reference voltage V0) is applied to the lower electrode 111. In this state, each of the luminous pixels PXe (luminous elements Eel) in the luminous area Rel corresponding to the display area Rpx is made to perform its luminous operation. Thereby the area corresponding to each of the luminous pixels PXe can be set to a black display or a white display, and desired image information (including character information) can be displayed. That is, the display area Rpx corresponding to each of the luminous pixels PXe (luminous elements Eel) of the luminous area Rel, that is, a device structure that is situated in the upper part of each of the luminous pixels PXe (luminous elements Eel) and includes the lower electrode 111, the upper electrode 113, and the white particles 115W and the black particles 115T, which are put between the lower electrode 111 and the upper electrode 113, in FIGS. 3, 4A, and 4B, severally has a function as a display pixel PXi. Moreover, when the upper electrode 113 and the lower electrode 111 were made to be in their high impedance states, the display panel 110 continues to perform the display in conformity with the first electric field or the second electric field that was formed just before their changes to the high impedance states.

Here the luminous pixels PXe in the luminous element array section 200 (array substrate 210) according to the present embodiment severally have the top emission type luminous structure, as described above, and consequently the optical path lengths from the luminous elements Eel on the array substrate 210 to the photoconductive layer 112 in the display panel 110 can be made to be shorter. Consequently the phenomenon in which a light emitted from a specific luminous pixel PXe (luminous element Eel) radiates an adjacent area (display pixel PXi) and the area neighboring the adjacent area in the photoconductive layer 112 to make the areas in conductive states can be suppressed, and the crosstalk to the adjacent display pixels can be prevented.

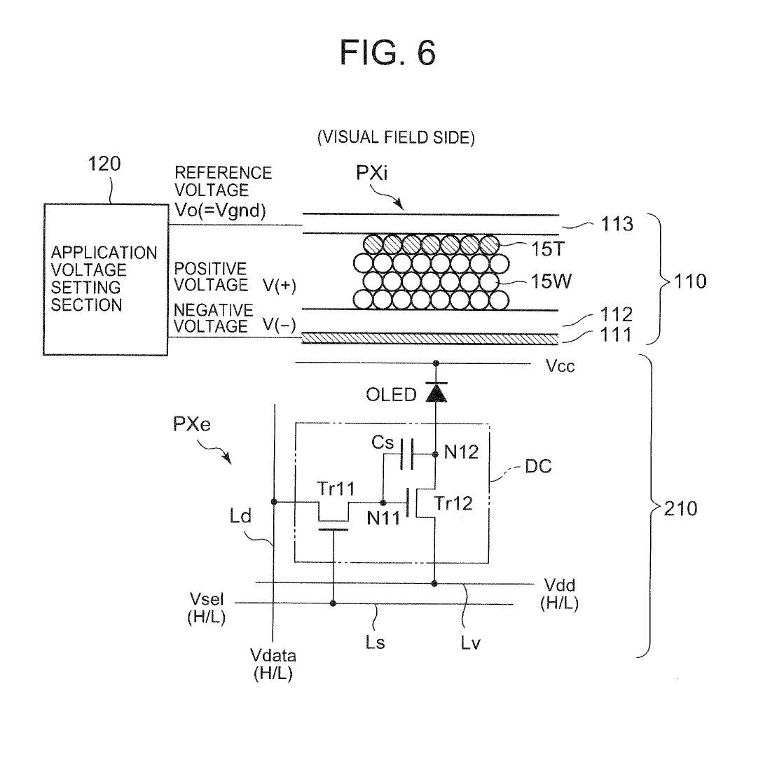

Moreover, since the luminous pixels PXe severally have the top emission type luminous structure, each circuit element (transistors Tr11 and Tr12 and the like shown in FIG. 6) in luminous drive circuits DC and each wiring layer that are formed on the substrate 211 can be arranged so as to overlap on the pixel electrodes 213 of organic EL elements OLED formed on the insulation films 212 and the like on a plane. Accordingly the luminous pixels and the display pixels can be miniaturized to raise display resolution, and the degree of freedom of the layout design of the luminous drive circuits DC can be raised.

Incidentally, the electric fields (first electric field and second electric field) generated between the photoconductive layer 112 (lower electrode 111) and the upper electrode 113 in the principle of operation described above are, strictly speaking, formed so as to widen from the side of the lower electrode 111 toward the upper electrode 113, and consequently the electric charges (+) and (−) generated in the surfaces of the photoconductive layer 112 and the upper electrode 113 are not situated at the opposed positions, but the electric charges (+) and (−) are shown at the opposed positions in FIGS. 4A and 4B on the supposition that the electric fields are generated substantially in parallel with each other for convenience of diagrammatic representation. The states of the electric charges (+) and (−) are also similarly shown in the drawings on and after FIGS. 4A and 4B.

Next, the white particles and black particle that can be applied to the display panel according to the present embodiment will be described.

In the present embodiment, as a first example, for example, spherical white particles of titanium oxide-containing cross-linked polymethylmethacrylate (Techpolymer MBX-20-White available from Sekisui Plastics Co., Ltd.), which are a mixture of impalpable powder of titania that is processed by isopropyl trimethoxy silane at a ratio by weight of 100 to 0.1 to have a volume-averaged particle diameter of 20 μm, can be well applied as the white particles 115W, which are charged to be negative (−). Moreover, for example, spherical black particles of carbon-containing cross-linked polymethylmethacrylate (Techpolymer MBX-20-Black available from Sekisui Plastics Co., Ltd.), which are a mixture of impalpable powder of Aerosil A130 (registered trade mark) that is processed by aminopropyl trimethoxy silane at a ratio by weight of 100 to 0.2 to have a volume-averaged particle diameter of 20 μm, can be well applied as the black particles 115T, which are charged to be positive (+).

As other examples having the characteristics equal to the characteristics of the aforesaid charged particles, as the white particles 115W, for example, the following particles can be applied: granular fine particles of titanium oxide-containing cross-linked polymethylmethacrylate (MBX-White (trade name) available from Sekisui Plastics Co, Ltd.), spherical fine particles of cross-linked polymethylmethacrylate (Chemisnow MX (trade name) available from Soken Chemical & Engineering Co., Ltd.), fine particles of polytetrafluoroethylene (Rubron L (trade name) available from Daikin Industries Ltd. and SST-2 (trade name) available from Shamrok technologies Inc.), fine particles of carbon fluoride (Tospearl (trade name) available from Momentive Performance Materials Inc.), fine particles of titanium oxide-containing polyester (Biryushia PL 1000 White T (trade name) available from Nippon Paint Co., Ltd), fine particles of titanium oxide-containing polyester acrylic (Conack No. 1800 White (trade name) available from NOF Corp.), and spherical fine particles of silica (Hipresica (trade name) available from Ube-Nitto Kasei Co., Ltd).

Moreover, as the black particles 115T, for example, the following particles can be applied: spherical particles including a cross-linked copolymer having divinyl benzene as the principal component thereof (Micropearl BB and Micropearl BBP (trade names) available from Sekisui Plastics Co., Ltd.) and spherical fine particles of cross-linked polymethylmethacrylate (MBX-Black (trade name) available from Sekisui Plastics Co., Ltd.). Moreover, as conductive black particles, the following fine particles can also be applied: fine particles of amorphous carbon produced by baking phenol resin particles (Univex GCP (trade name) available from Unitika Ltd.), and carbonaceous and graphite spherical fine particles (Nicabeads ICE, Nicabeads MC, and Nicabeads PC (trade names) available from Nippon Carbon Co., Ltd.).

Incidentally, when the white particles 115W and black particles 115T represented by the charged particles mentioned above are applied to the electric paper display section 100 (display panel 110) according to the aforesaid present embodiment, the white particles 115W and the black particles 115T are mixed at a ratio by weight of, for example, 2 to 1, and the mixture is sealed in the gap between the photoconductive layer 112 (lower electrode 111) and the upper electrode 113 so that the quantity of the mixture may be, for example, about 10% or more to the volume of the gap.

Moreover, as second examples of the white particles and black particles that can be applied to the present embodiment, for example, the fine particles equal to the well-known conductive toner (black toner) (that is, carbon and graphite-based granular particles), which are used for a fax communication machine, a copier, a laser printer, and the like, can be applied as the black particles, and slippery fine particles such as carbon fluoride can be applied as the white particles In this case, when the black particles (black toner), which are easily charged to be positive (+), move to either of the photoconductive layer 112 (lower electrode 111) and the upper electrode 113, which is charged to be negative (−), by coulombic attraction, the black particles sneak through the white particles, which are difficult to be charged, to move.

Next, the luminous spectral characteristics of the luminous elements that can be applied to the array substrate 210 according to the present embodiment and the spectral sensitivity characteristics of the photoconductive layer 112 that can be applied to the display panel 110 will be verified.

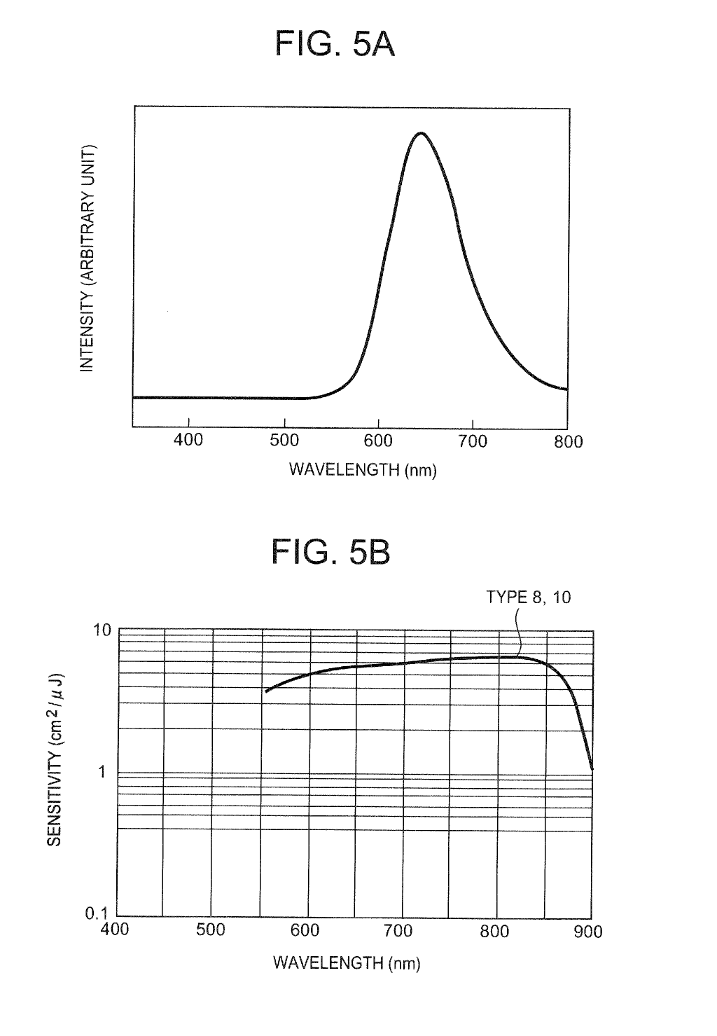

FIG. 5A is a characteristic diagram showing a luminous spectral characteristic of a luminous element capable of being applied to the array substrate 201 according to the present embodiment, and FIG. 5B is a characteristic diagram showing a spectral sensitivity characteristic of the photoconductive layer 112 capable of being applied to the display panel 110.

If the luminous spectral characteristic of the luminous element Eel capable of being applied to the array substrate 210 of the display apparatus according to the present embodiment and the spectral sensitivity characteristic of the photoconductive layer 112 capable of being applied to the display panel 110 are verified, then the luminous spectral characteristic in the case of applying an organic EL element to emit a red color light as the luminous element Eel has a peak of luminescence intensity at the wavelength in the vicinity of about 645 nm, for example, as shown in FIG. 5A. As the spectral sensitivity characteristic required for the photoconductive layer 112 corresponding to the luminous spectral characteristic of the organic EL element (luminous element) to emit this sort of red color light, for example, as shown in FIG. 5B, it is desirable to have a light sensitivity (spectral sensitivity characteristic) high in the wavelength of about 600 nm or longer. Here the characteristic line in FIG. 5B shows the spectral sensitivity characteristic of negative charge type OPC Types 8 and 10 available from Fuji Electric Device Technology Co., Ltd., and both of the photo conductive materials show spectral sensitivities high (about 4 to 6 cm²/μJ) in the wavelength band including the vicinity of about 645 nm. Consequently, photo conductive materials can be well applied to the present embodiment. Incidentally, although the luminous elements Eel radiate red color lights, the emitted light is not limited to the red ones, but the luminous elements Eel may be ones emitting a green color light, a blue color light, or a white color light according to the spectral sensitivity characteristic of the photoconductive layer 112.

### (Instantiation of Luminous Pixel)

Next, a luminous pixel applied to the display apparatus of the embodiment of the present invention will be concretely described.

A pixel equipped with a self-luminous type luminous element Eel, such as an organic EL element, can be applied as each of the luminous pixels PXe, which are two-dimensionally arranged on the array substrate 210. Here the luminous elements Eel are not limited to the organic EL elements, but the luminous elements Eel may be the other luminous elements such as self-luminous element, for example, an inorganic EL device, a light emitting diode (LED), and a surface emitting laser as long as the luminous elements emit lights of the wavelengths enabling the photoconductive layer 112 to be set in an arbitrary charged state by the irradiated lights from the luminous elements Eel as a drive control method described below.

Moreover, a luminous drive method of the luminous elements Eel arranged in the array substrate 210 may be either of the passive drive method and the active drive method in the principle of operation of the drive method of the aforesaid display apparatus, but the active drive method, which can reduce instantaneous luminance, is more preferable.

In the following, the circuit configuration of a luminous pixel in the case of applying the active drive method will be described.

FIG. 6 is a schematic diagram showing a circuit configuration example of a luminous pixel that is applied to the display apparatus of the present embodiment.

As shown in FIG. 6, for example, a circuit configuration including an organic EL element OLED, which is a luminous element Eel, and the luminous drive circuit DC equipped with a plurality of switching elements (transistors) to control a luminous drive current to be supplied to the luminous element Eel can be applied as each of the luminous pixels PXe in the case of applying the active drive method.

The luminous drive circuit DC includes, for example, as shown in FIG. 6, a transistor (selection transistor) Tr11, a transistor (drive transistor) Tr12, and a capacitor Cs. The transistor Tr11 is equipped with a gate terminal connected to a selection line Ls arranged in a row direction of the array substrate 210, a drain terminal connected to a data line Ld arranged in a column direction of the array substrate 210, and a source terminal connected to a node N11. The transistor Tr12 is equipped with a gate terminal connected to the node N11, a drain terminal connected to a power supply voltage line Lv arranged in a row direction of the array substrate 210, and a source terminal connected to a node N12. The capacitor Cs is connected between the gate terminal and the source terminal of the transistor Tr12.

The organic EL elements OLED is equipped with an anode terminal (pixel electrode 213 functioning as an anode electrode) connected to the node N12 of the luminous drive circuit DC and a cathode terminal (cathode electrode) integrally formed with the counter electrode 215 to be connected to a predetermined fixed voltage Vcom (for example, the ground potential Vgnd) directly or indirectly. Here the counter electrode 215 is formed of a single electrode (solid electrode) so as to be commonly opposed to, for example, the pixel electrodes 213 of the plurality of luminous pixels PXe two-dimensionally arranged on the array substrate 210.

Here in the luminous pixel PXe (luminous drive circuit DC and organic EL elements OLED) shown in FIG. 6, the selection line Ls is connected to the selection voltage setting section 230 shown in FIG. 2B, and, for example, a selection voltage Vsel for setting the plurality of luminous pixels PXe arranged in the row direction of the array substrate 210 to be in the selected sate at predetermined timing on the basis of the selection control signal from the system controller 300. The selection voltage Vsel is a signal for making the organic EL element OLED emit a light, and is a voltage sufficiently smaller than the potential difference between the lower electrode 111 and the upper electrode 113 (positive voltage V(+)−reference voltage V0 and negative voltage V(−)−reference voltage V0). Consequently, the selection voltage setting section 230 is not required to be a driver having a resistance property to high potential difference.

Moreover, the data line Ld is connected to the data voltage setting section 220 shown in FIG. 2B, and data voltage Vdata based on the display data is applied onto the data line Ld at the timing synchronized with the selection states of the luminous pixels PXe on the basis of the data control signal from the system controller 300. The data voltage Vdata is a signal for making the organic EL elements OLED emit lights and is a signal sufficiently smaller than the potential difference (positive voltage V(+)−reference voltage V0 and negative voltage V(−)−reference voltage V0) between the lower electrode 111 and the upper electrode 113. Consequently the data voltage setting section 220 is not required to be a driver having a resistance property to high potential difference.

The power supply voltage line Lv is connected to the power supply voltage setting section 240 shown in FIG. 2B, and a power supply voltage Vdd is applied onto the power supply voltage line Lv on the basis of the power supply control signal from the system controller 300. Here both of the selection voltage Vsel and the data voltage Vdata are set to binary voltages of a high level or a low level, each set to be a predetermined voltage value. Incidentally, the power supply voltage Vdd is a constant voltage, which is a higher potential voltage than the fixed voltage Vcom applied to the counter electrode 215 of the organic EL elements OLED in order to make a predetermined drive current for a luminous operation flow through the pixel electrodes 213 of the organic EL elements OLED. The power supply voltage setting section 240 is only required to output the power supply voltage Vdd or to realize high impedance, and the output signals from the power supply voltage setting section 240 have no potential difference. Consequently, the power supply voltage setting section 240 is not required to be a driver having any resistance properties to high potential differences.

That is, in the luminous pixel PXe shown in FIG. 6, the power supply voltage Vdd and the fixed voltage Vcom (=Vgnd) are applied to both the ends of a couple of the serially connected transistor Tr12 and organic EL element OLED (the drain terminal of the transistor Tr12 and the cathode terminal of the organic EL element OLED), respectively, and a forward bias is given to the organic EL element OLED to change the organic EL element OLED to be in the state of capable of emitting a light. Furthermore, it is controlled whether to make a luminous drive current flow through the organic EL element OLED or not (whether to supply the luminous drive current or whether to block the current) according to the data voltage Vdata (luminous level or nonluminous level) applied from the setting section 220. Thereby the luminous state (luminous operation or nonluminous operation) of the luminous element is controlled. The concrete luminous drive method will be described with regard to the drive method of the display apparatus, which will be described later.

Incidentally, as the luminous drive circuit DC (see FIG. 6) provided in the luminous pixel PXe, the present embodiment illustrates the circuit configuration corresponding to a voltage specifying type luminous drive system of setting luminous and nonluminous operations by specifying the voltage value (high level or low level) of a data voltage Vdata to be written into each of the luminous pixels PXe (specifically the gate terminal of the transistor Tr12 of the luminous drive circuit DC: node N11) according to display data, and thereby controlling the supply and block of the luminous drive current to be made to flow through the organic EL element OLED, but the luminous drive circuit DC may be the one having the circuit configuration of a current specifying type luminous drive system of setting the luminous and nonluminous operations by specifying the current value (supply or block) of a current to be supplied (written) to each of the luminous pixels PXe according to display data, and thereby controlling the supply and block of the luminous drive current to be made to flow through the organic EL element OLED.

Moreover, although the luminous drive circuit DC shown in FIG. 6 has the circuit configuration in which two n-channel type transistors Tr11 and Tr12 are applied, luminous drive circuit DC of the display panel according to the present invention is not limited to the aforesaid type. The luminous drive circuit DC may be the one having the other circuit configuration in which three or more transistors are applied Furthermore, the circuit configuration of the luminous drive circuit DC may be the one in which only p-channel type transistors are applied, or the one in which the transistors having the channel polarities including both of the n-channel type ones and the p-channel type ones are intermixed. Moreover, the transistors may be amorphous silicon thin film transistors or may be polysilicon thin film transistors.

### (Drive Method of Display Apparatus)

Next, the drive method of the display apparatus according to the present embodiment will be described.

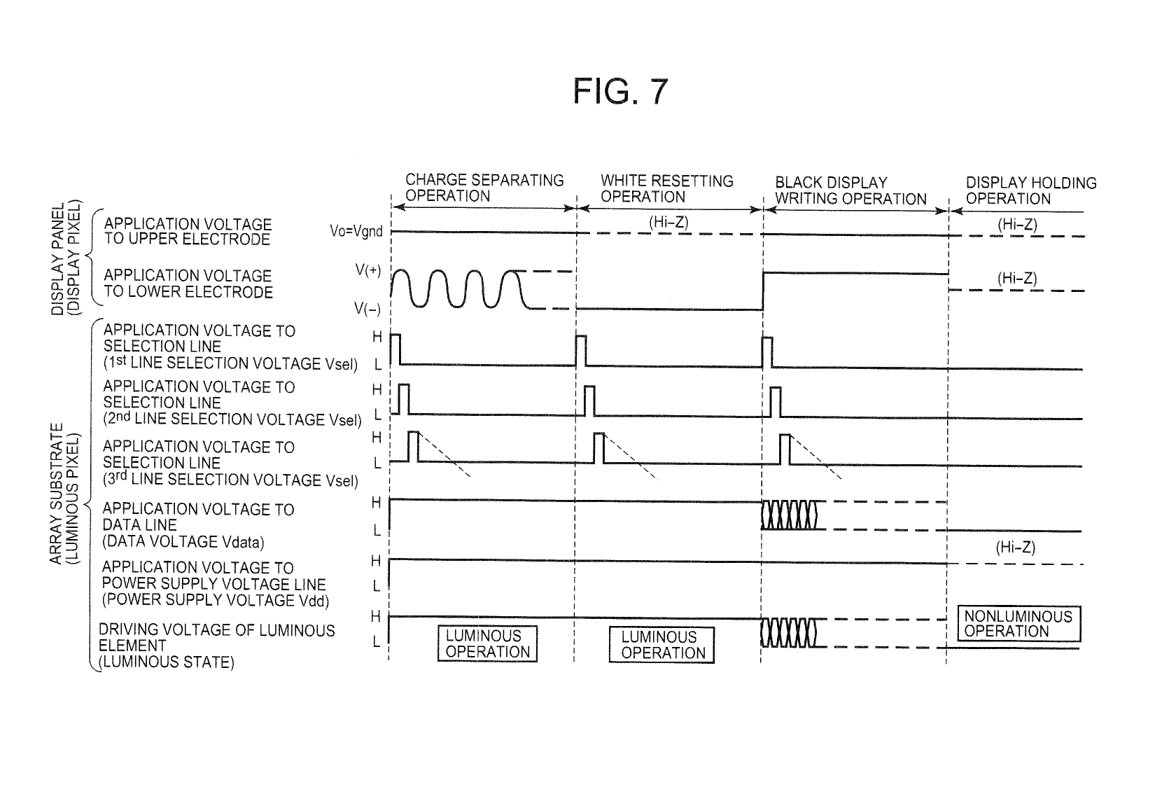

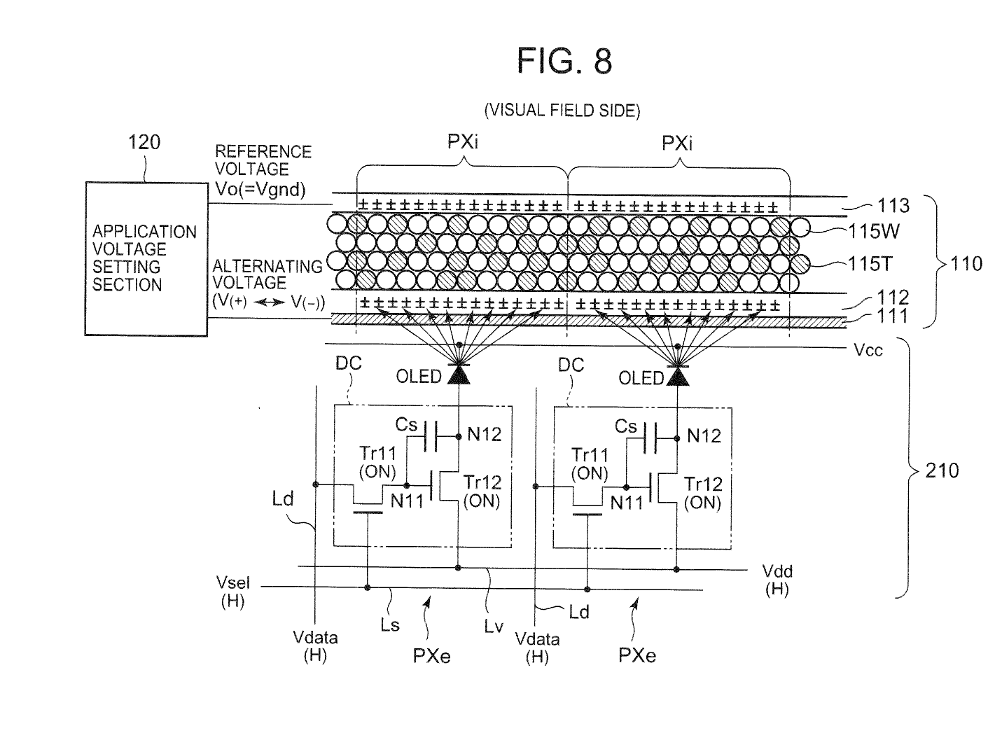

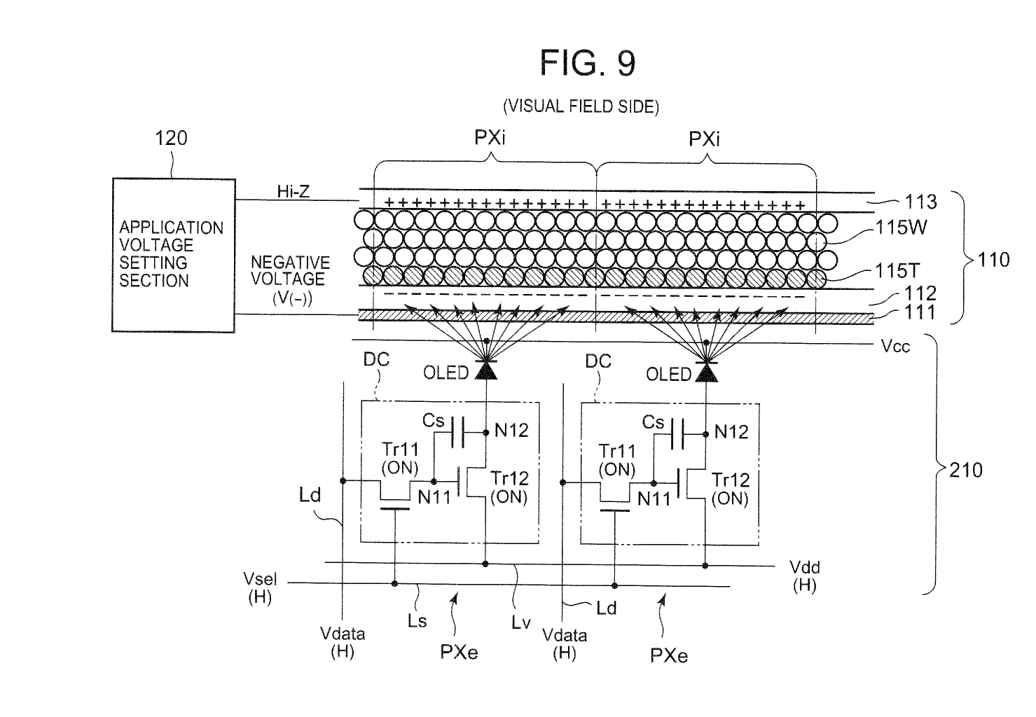

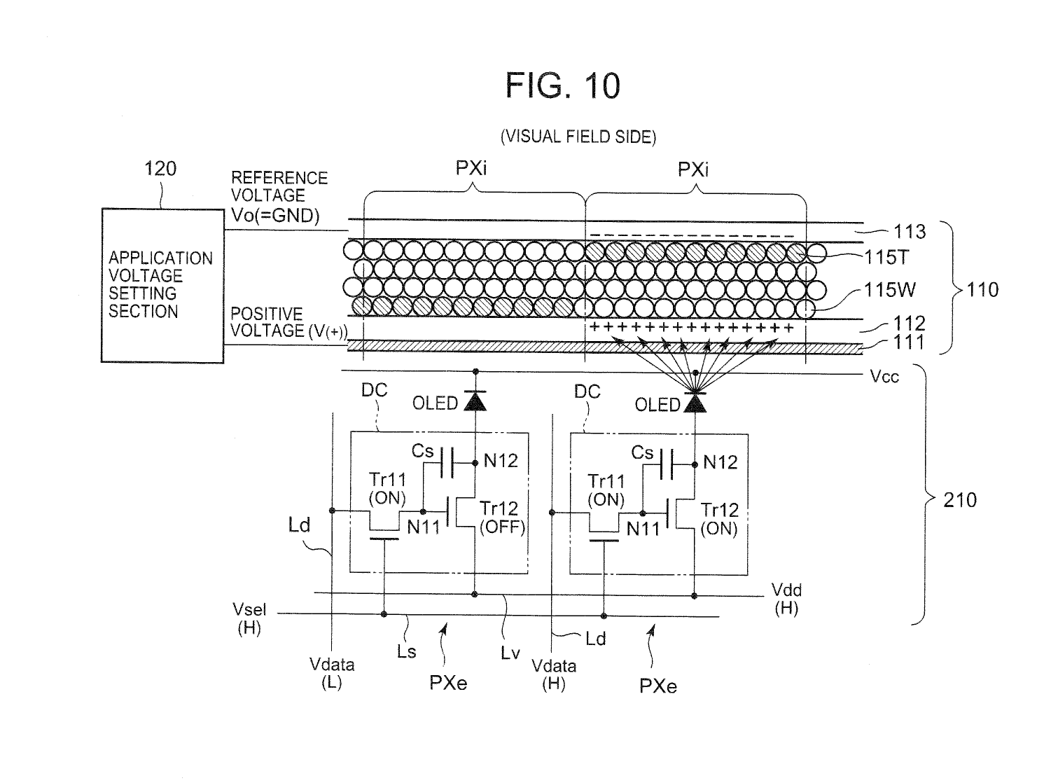

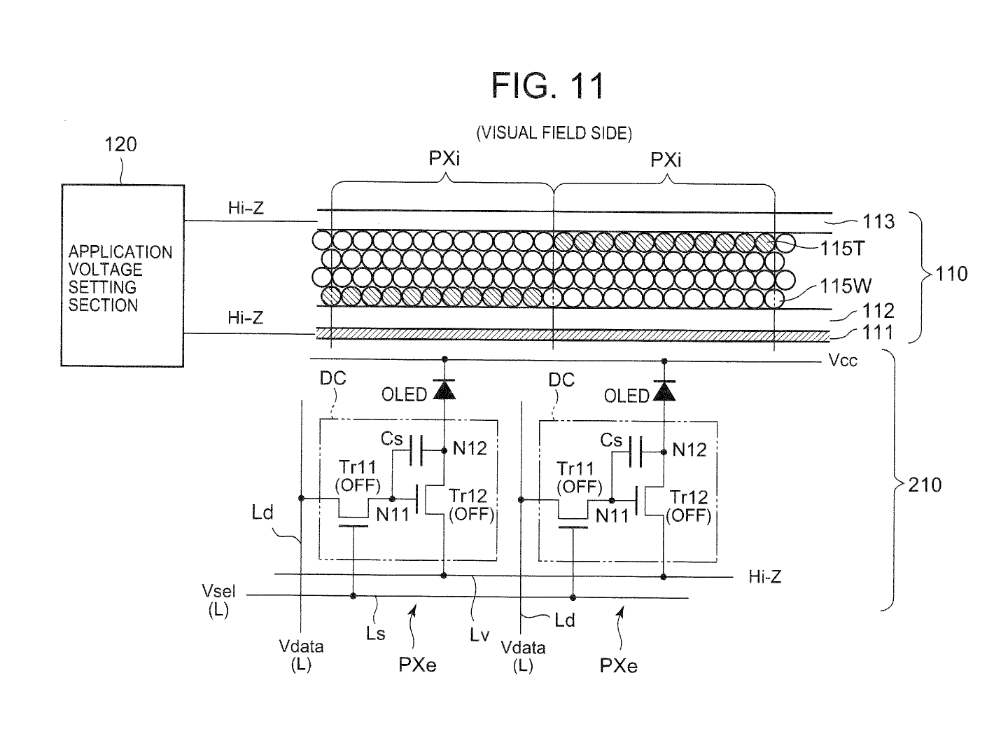

FIG. 7 is a timing chart showing an example of a normally white display drive operation (drive method) of the display apparatus according to the present embodiment. Moreover, FIG. 8 is a schematic state diagram showing a charge separating operation in the display drive operation according to the present embodiment; FIG. 9 is a schematic state diagram showing a white resetting operation in the display drive operation according to the present embodiment; FIG. 10 is a schematic state diagram showing a black display writing operation in the display drive operation according to the present embodiment; and FIG. 11 is a schematic state diagram showing a display holding operation in the display drive operation according to the present embodiment. Here the sectional configurations equal to those of the device structures described above are denoted by the same marks as those of the device structures to be described.

As shown in FIG. 7, the drive method of the display apparatus according to the present embodiment sequentially executes a charge separating operation, a white resetting operation, and a black display writing operation in a predetermined display operation period, following which the drive method executes a writing holding operation. The charge separating operation applies an alternating electric field between the photoconductive layer 112 (lower electrode 111) and the upper electrode 113 to give different electric charges to the respective white particles 115W and the black particles 115T. The white resetting operation makes the whole display area Rpx perform white display operations to display a background. The black display writing operation performs writing in the areas (display pixels) to be black displays for showing images such as characters in the background of the white display based on display data. The writing holding operation holds the image information (that is the white display state and the black display state) written in the display area Rpx. That is, the present embodiment once executes the white resetting operation to the whole display area Rpx of the display panel 110 to set the display area Rpx in the white display state After that, the present embodiment is controlled to sequentially execute the operation of setting only the areas (display pixels) corresponding to the image information to be displayed to the black display states on the basis of display data every display pixel two-dimensionally arranged into the row directions and column directions in the display area Rpx (that is, the area corresponding to each of the luminous pixels PXe two-dimensionally arranged in the array substrate 210) or every row. Incidentally, this sort of series of drive control operations is controlled to be executed by generating and outputting various control signals by the system controller 300 shown in FIGS. 2A and 2B.

In the following, each of the operations will be minutely described.

### (Charge Separating Operation)

First, in the charge separating operation, as shown in FIG. 8, the reference voltage V0 is applied to the upper electrode 113 of the display panel 110, and an alternating voltage to alternately take positive electric potential and negative electric potential to the reference voltage V0 is applied to the lower electrode 111. In this state, all of the luminous pixels PXe (luminous elements Eel) arranged on the array substrate 210 are made to perform a luminous operation. Thereby, the photoconductive layer 112 is made to be in its conductive state, and positive charges (+) and negative charges (−) are alternately generated on the surface of the photoconductive layer 112. Thus, an alternating electric field is formed between the photoconductive layer 112 (lower electrode 111) and the upper electrode 113. Thereby, the white particles 115W and the black particles 115T put between the photoconductive layer 112 and the upper electrode 113 are stirred according to the directions of the electric field to be rubbed against each other. Thus charge separation, in which the white particles 115W are charged to be negative charges and the black particles 115T are charged to be positive charges, arises.

To put it concretely, as shown in FIGS. 7 and 8, in the electric paper display section 100, the reference voltage V0 (=Vgnd) is applied from the application voltage setting section 120 to the upper electrode 113 of the display panel 110, shown in FIG. 2A, and the alternating voltage to alternately take the positive electric potential and the negative electric potential to the reference voltage V0 to the lower electrode 111 on the basis of the voltage control signal from the system controller 300. In this state, in the luminous element array section 200, the data voltage Vdata and the power supply voltage Vdd, both being the high levels, are applied to all the luminous pixels PXe on the array substrate 210 from the data voltage setting section 220, the power supply voltage setting section 240, and the selection voltage setting section 230, shown in FIG. 2B, through the data line Ld, the power supply voltage line Lv, and the selection line Ls, respectively, on the basis of the various control signals from the system controller 300, and the selection voltages Vsel of the on-level (high level) are sequentially applied to each of the luminous pixels PXe in each row of the array substrate 210 (luminous area Rel) (selection state). Thereby, the transistor Tr11 provided in the luminous drive circuit DC of each of the luminous pixels PXe performs its on-operation. Then, as electric charges are accumulated in the capacitor Cs connected between the gate and the source of the transistor Tr12, the gate voltage (electric potential at the node N11) of the transistor Tr12 rises. Thus, the transistor Tr12 performs its on-operation, and the predetermined luminous drive current is supplied to the organic EL element OLED to make the luminous pixels PXe (organic EL elements OLED) on the array substrate 210 emit lights every row. Such luminous operations are repeatedly executed to all the rows in the luminous area Rel.

Here the luminous operation of the organic EL elements OLED in the luminous pixels PXe of each row are performed as the selection state, and then the selection voltage Vsel of the off-level (low level) is applied to the luminous pixels PXe of each row to make the luminous pixels PXe be in their non-selection states (the states of keeping the power supply voltage Vdd). Even in this case, the gate voltages (the electric potential at the nodes N11) of the transistors Tr12 are held by the capacitors Cs, and consequently the luminous states of the luminous pixels PXe (organic EL elements OLED) are held. Thus the state in which all of the luminous pixels PXe in the array substrate 210 (luminous area Rel) emit lights is realized.

At this time, since the electric charges generated on the surface of the photoconductive layer 112 and the electric charges generated on the upper electrode 113 correspondingly to the former electric charges are changed according to the voltage (positive voltage or negative voltage) applied to the lower electrode as shown in FIGS. 4A and 4B, an alternating electric field, which changes with time, is generated between the photoconductive layer 112 (lower electrode 111) and the upper electrode 113. Consequently, the white particles 115W and the black particles 115T are stirred to be mixed according to the alternating electric field (that is, the directions of the electric field), and then the white particles 115W and the black particles 115T are rubbed against each other. Thus, the white particles 115W are charged to be negative charges (−) and the black particles 115T are charged to be positive charges (+) over the whole area of the charge display area Rpx, and the white particles 115W and the black particles 115T are in a state in which their electric charges are separated.

Incidentally, in the charge separating operation, as shown in the timing chart of FIG. 7, the alternating electric field is generated between the upper electrode 113 and the photoconductive layer 112 (lower electrode 111). The case of applying a voltage having a sine waveform as the alternating voltage to be applied to the lower electrode 111 has been described, but the waveform of the alternating voltage is not limited to the sine waveform, but the voltages having the waveforms of a rectangular wave, a triangular wave, and the like, may be applied.

### (White Resetting Operation)

Next, in the white resetting operation, as shown in FIG. 9, the application of the reference voltage V0 to the upper electrode 113 of the display panel 110 is blocked, and a voltage V(−) of negative electric potential to the reference voltage V0 is applied to the lower electrode 111 In this state, the luminous operations of all of the luminous pixels PXe (luminous elements Eel) arranged in the array substrate 210 are performed to change the photoconductive layer 112 into its conductive state. Thereby, negative charges (−) are generated on the surface of the photoconductive layer 112, and positive charges (+) are generated on the surface of the upper electrode 113. Thereby the black particles 115T are moved to the side of the photoconductive layer 112, and the white display of the whole area of the display area Rpx is performed.

To put it concretely, as shown in FIGS. 7 and 9, the aforesaid state in the charge separating operation, in which all of the luminous pixels PXe of the array substrate 210 (luminous area Rel) are made to emit lights, is kept, and in the electric paper display section 100 the application of the reference voltage V0 from the application voltage setting section 120 to the upper electrode 113 of the display panel 110 is blocked to set the upper electrode in a high impedance state on the basis of the voltage control signal from the system controller 300. Furthermore, the voltage V(−) of negative electric potential to the reference voltage V0 is applied to the lower electrode 111.

Thereby, as shown in FIG. 4B, negative charges are generated on the surface of the photoconductive layer 112 according to the voltage (negative voltage) applied to the lower electrode 111, and positive charges are generated on the surface of the upper electrode 113 correspondingly to the generation of the negative charges. Thus, an electric field (second electric field) is generated between the photoconductive layer 112 and the upper electrode 113 Consequently, the black particles 115T charged to the positive charges (+) by the charge separating operation mentioned above according to the electric field move to the surface of the photoconductive layer 112 as if the black particles 115T are drawn nearer to the surface. On the other hand, the white particles 115W charged to negative charges (−) move to the surface of the upper electrode 113, which is the visual field side, and the neighborhood thereof as if the white particles 115W are drawn nearer to the surface. Consequently, the whole area of the display area Rpx is set in the white display state (white reset).

Then, after the completion of the white resetting operation, the electric potential of the drains of the transistors Tr12 is changed from the power supply voltage Vdd applied to the luminous pixels PXe to the high impedance (Hi-Z), and, the supply of the luminous drive currents from the luminous drive circuits DC to the organic EL elements OLED is blocked. Thus all of the luminous pixels PXe (organic EL elements OLED) of the array substrate 210 (luminous area Rel) kept in the luminous states are put out, and are set in non-luminous states once.

Incidentally, in the white resetting operation, as shown in the timing chart of FIG. 7, the case where the voltage V(−) of the negative electric potential to the reference voltage V0 is applied to the lower electrode 111 of the display panel 110 and the application of the reference voltage V0 to the upper electrode 113 is blocked to set the upper electrode 113 in the high impedance state and thereby the predetermined electric field (second electric field) between the photoconductive layer 112 (lower electrode 111) and the upper electrode 113 is generated has been described, but the invention is not limited to that case. The voltage applied to the upper electrode 113 may be the reference voltage V0 similarly to the case of the charge separating operation mentioned above, or may be an arbitrary voltage relatively higher than the voltage V(−) applied to the lower electrode 111.

### (Black Display Writing Operation)

Next, in the black display writing operation, as shown in FIG. 10, the reverence voltage V0 is applied to the upper electrode 113 of the display panel 110, and a voltage of positive electric potential to the reference voltage V0 is applied to the lower electrode 111 In this state, the luminous operation of the luminous pixel PXe (luminous element Eel) of the array substrate 210 corresponding to the area of the display panel 110 (display area Rpx) in which image information is written on the basis of display data, that is, the area (display pixel) set to be in the black display state according to the image information, is performed, and thereby the photoconductive layer 112 in the area is made to be in its conductive state to cause the generation of positive charges (+) on the surface thereof. Furthermore, negative charges (−) are generated on the surface of the upper electrode 113. Then, the black particles 115T are moved to the side of the upper electrode 113, and the black display of only the specific area (display pixel) in the display area Rpx is performed.

To put it concretely, as shown in FIGS. 7 and 10, in the electric paper display section 100, the reference voltage V0 (=vgnd) is applied from the application voltage setting section 120 to the upper electrode 113 of the display panel 110 and the voltage V(+) of the positive electric potential to the reference voltage V0 is applied to the lower electrode 111 on the basis of the voltage control signal output from the system controller 300 on the basis of display data. In this state, in the luminous element array section 200, the selection voltage Vsel of the on-level is sequentially applied (selection state) from the selection voltage setting section 230, the power supply voltage setting section 240, and the data voltage setting section 220 to each of the luminous pixels PXe in each row of the array substrate 210 (luminous area Rel) through the selection line Ls and the power supply voltage line Lv on the basis of various control signals output from the system controller 300 on the basis of display data, and the data voltage Vdata of the luminous level is applied only to each of the luminous pixels PXe corresponding to the areas (display pixels) of the display panel 110 (display area Rpx) in which black display writing is performed, through the data line Ld. At this time, the power supply voltage Vdd is applied to the drains of the transistors Tr12. Thereby, the transistor Tr11 provided in the luminous drive circuit DC of each of the luminous pixels PXe performs its on-operation, and electric charges are accumulated in the capacitors Cs connected between the gates and the sources of the transistors Tr12. Then the rises of the gate voltages (electric potential at the nodes N11) of the transistors Tr12 make the transistors Tr12 perform their on-operations, and predetermined luminous drive currents are supplied to the organic EL elements OLED. Thereby, only the luminous pixels PXe (organic EL elements OLED) corresponding to the display pixels into which black display writing is performed emit lights (lighting) in each row. The aforesaid operation is repeatedly performed to all of the rows in the luminous area Rel. On the other hand, in the luminous pixels PXe corresponding to the display pixels into which black display writing is not performed, the data voltages Vdata of the nonluminous level are applied through the data lines Ld, and thereby the transistors Tr12 are turned to their off-state and the organic EL elements OLED are made to perform their nonluminous (putting out) operations.

At this time, as shown in FIG. 4A, positive charges are generated on the surface of the photoconductive layer 112 according to the voltage (positive voltage) applied onto the lower electrode ill in the area in which black display writing is performed, and negative charges are generated on the surface of the upper electrode 113 correspondingly to the generation of the positive charges. An electric field (first electric field) is thus generated between the photoconductive layer 112 and the upper electrode 113. Consequently, the black particles 115T, which have moved to the side of the photoconductive layer 112 (lower electrode 111) by the white setting operation mentioned above, move to the surface of the upper electrode 113, which is charged to negative charges, on the visual field side as if the black particles 115T are drawn nearer to the upper electrode 113 according to the electric field. On the other hand, the white particles 115W move to the surface of the photoconductive layer 112 charged to positive charges and the vicinity thereof as if the white particles 115W are drawn nearer to the surface. Consequently, the specific areas (display pixels) based on display data in the display area Rpx are set to the black display states (black display writing), and desired image information is displayed.

### (Display Holding Operation)

Next, in the display holding operation, as shown in FIG. 11, after the completion of the aforesaid black display writing operation, each of the luminous pixels PXe (organic EL elements OLED) in the array substrate 210 (luminous area Rel) that have been kept in their luminous states is put out and is set into the non-luminous state thereof. Furthermore, the supply of the voltages to the lower electrode 111 and the upper electrode 113 of the display panel 110 is blocked, and thereby written image information is held.

To put it concretely, as shown in FIGS. 7 and 11, in the electric paper display section 100, the application of the voltages onto the lower electrode 111 and the upper electrode 113 of the display panel 110 from the application voltage setting section 120 is blocked on the basis of a voltage control signal output from the system controller 300 to set the lower electrode 111 and the upper electrode 113 to be in their high impedance states. Moreover, the luminous element array section 200 applies the selection voltages Vsel of the off-level (low level) (non-selection state) from the selection voltage setting section 230, the power supply voltage setting section 240, and the data voltage setting section 220 to the luminous pixels PXe of each row of the array substrate 210 (luminous area Rel) through the selection line Ls and the power supply voltage line Lv on the basis of various control signals output from the system controller 300, and applies the data voltage Vdata of the nonluminous level to each of the luminous pixels PXe through the data line Ld. At this time, the drains of the transistors Tr12 has been changed from the power supply voltage Vdd to a high impedance. Thereby, the transistors Tr11 and Tr12 provided in the luminous drive circuit DC of each of the luminous pixels PXe are made to be in their off-states, and then the nonluminous (putting out) operations of the organic EL elements OLED are performed.

At this time, because the black particles 115T include very few residual electric charges and a very small diffusion coefficient, their charged states are held even in the state of applying no electric fields between the upper electrode 113 and the photoconductive layer 112 (lower electrode 111), and the state in which image information is displayed on the display panel 110 (display area Rpx) is kept.

Incidentally, the case of setting the data voltage Vdata, the selection voltage Vsel, and the electric potential of the drains of the transistors Tr12 are set to the nonluminous level, the off-level, and a high impedance (Hi-Z), respectively, as shown in the timing chart of FIG. 7, in order to hold each of the luminous pixels PXe in the array substrate 210 (luminous area Rel) in the non-luminous state thereof has been described in the aforesaid display holding operation, but the setting of each of the voltages Vata and Vsel and the electric potential is not limited to the state mentioned above. The settings may be also the ones in which the operations of the data voltage setting section 220, the selection voltage setting section 230, and the power supply voltage setting section 240 are stopped and the application of the data voltage Vdata, the selection voltage Vsel, and the power supply voltage Vdd to the data line Ld, the selection line Ls, and the power supply voltage line Lv, respectively, is blocked to set them in high impedance states. By these settings, the dissipation power of the display apparatus can be reduced by a large margin.

As described above, according to the display apparatus and the drive control method thereof of the present embodiment, the display area of the display panel (electric paper display section) having an electric paper structure and the luminous area of the array substrate (luminous element array section) having a luminous element array structure are arranged to be laminated so as to overlap with each other in a plane; predetermined voltages are applied between the upper electrode and the lower electrode of the display panel according to display data; a predetermined electric field is generated between the upper electrode and the lower electrode (photoconductive layer) by making a luminous pixel (luminous element) in the array substrate emit a light; the black particle and the white particles are moved to either side of the upper electrode on the visual field side and the lower electrode; and thereby desired image information can be displayed.

Consequently, since desired image information can be written (displayed) securely and well only by applying a voltage having a predetermined voltage value from the application voltage setting section to the upper electrode and the lower electrode of the display panel (electric paper display section) to radiate a light of a predetermined wavelength from the array substrate (luminous element array section) at the time of writing image information (black display writing), the display apparatus and the drive control method thereof according to the present embodiment do not apply any high voltage signals, which are display data (image information), to the electrodes divided every pixel as the electric paper according to the related art, and consequently the display apparatus and the drive control method thereof according to the present embodiment do not need to use any dedicated display drivers of high withstand voltages and any display switching elements (transistors and the like) for applying voltage signals of high potential differences to the display electrode. Thus, the reduction of the development cost of the display apparatus and the shortening of the development period can be attained.

Moreover, the drive method shown in the present embodiment executes the white resetting operation after the performance of the charge separating operation to the display panel 110 (white particles 115W and black particles 115T) to rewrite the whole are of the display area Rpx to the white display state once, following which the drive method executes the black display writing operation to rewrite the area (display pixel) corresponding to image information to the black display state. Consequently, a visual quality of a white ground (background), which is a feature of the display apparatus of the electric paper structure, can be secured. That is, the drive method of the present embodiment can improve the problem in which the visual quality of the white ground is damaged by the areas (display pixels) in which image information is not written remain in a charge separation state or a previous image displaying state.

Incidentally, the present embodiment has been described with regard to the case where only the areas corresponding to image information are rewritten to the black display state by the black display writing operation after setting the whole area of the display area to the white display state by the white resetting operation in order to display the ground (background) of the image information in white and to display the image information in black, but the present invention is not limited to such a method. The method of rewriting only the areas corresponding to the image information to the white display state after setting the whole area of the display area to the black display state (black resetting operation) may be adopted. In this case, the image information is display by white in a black ground (black background).

Moreover, although the device structure in which black particles and white particles are put between the lower electrode (photoconductive layer) and the upper electrode in the state of being mixed with each other has been described in the present embodiment, the present invention is not limited to such a device structure. Any of the structures for performing black display operations or white display operations according to electric fields generated by the voltages applied between the lower electrode and the upper electrode can be adopted. For example, the structure of putting the so-called micro capsules and an insulative liquid between both the electrodes (see the aforesaid Japanese Patent Application Laid-Open Publication No. 2003-161822) may be adopted; the structure of putting twisting balls between both of the electrodes by using a silicone resin as a binder may be adopted; and the structure of putting a host-guest liquid crystal, which is a mixture of a smectic A liquid crystal, which has a memory property, and a dichromatic dye, between both the electrodes.

Furthermore, although the present embodiment has been described with regard to the case where the black particles and the white particles are mixed and dispersed as the electrifiable particles to be sealed between the lower electrode (photoconductive layer) and the upper electrode, the present invention is not limited to the case. As described below, electrifiable particles having arbitrary colors may be used by being combined to be sealed between the electrodes.

### Second Embodiment

Next, a display apparatus and a drive method thereof according to a second embodiment will be described.

### (Device Structure of Display Apparatus)

First the device structure of the display apparatus according to the second embodiment will be described.

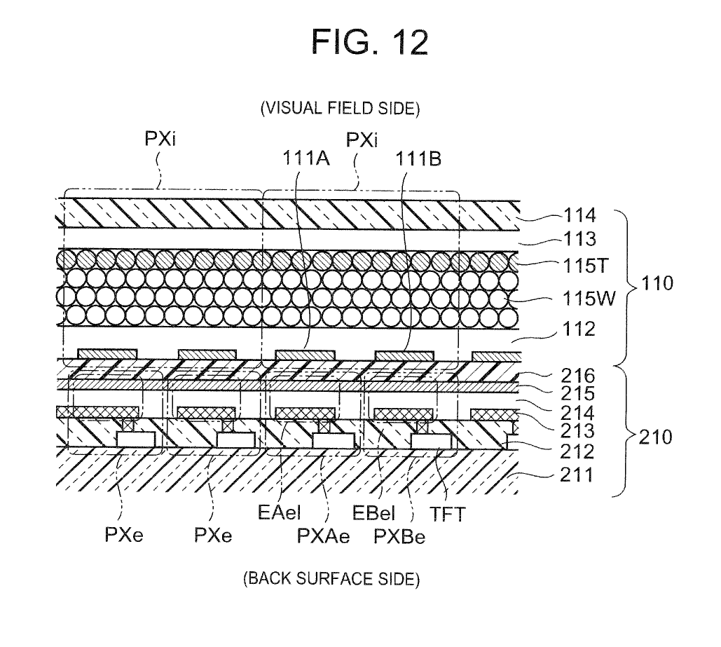

FIG. 12 is a principal part sectional view showing the device structure of the display apparatus according to the second embodiment. Here the configurations equal to those of the first embodiment (see FIG. 3) are denoted by the same or equal marks as those of the first embodiment, and their descriptions will be simplified or omitted. Incidentally, also in FIG. 12, the showing of a part of hatchings indicating cross sections is omitted for convenience of diagrammatic representation.

The display apparatus according to the second embodiment has the device structure of joining the electric paper display section 100 with the luminous element array section 200 so as to adhere closely to each other so that the display area Rpx of the electric paper display section 100 may overlap with the luminous area Rel of the luminous element array section 200 in a plane as shown in FIGS. 1A, 1B, 2A and 2B, and the lower electrodes provided in the display panel 110 of the electric paper display section 100 are not the one of a single solid electrode, but are formed as a pair of electrode layer (lower electrodes 111A and 111B) divided in each unit area, or a display pixel PXi, in the former structure as shown in FIG. 12. Moreover, individual luminous pixels PXAe and PXBe are formed so as to correspond to the pair of the lower electrodes 111A and 111B, respectively, in the array substrate 210 of the luminous element array section 200 provided to the lower part of the display panel 110.

Then, a negative voltage is applied from the application voltage setting section 120 to the lower electrode 111A on one side, and a positive voltage is applied from the application voltage setting section 120 to the lower electrode 111B on the other side. The display apparatus has a panel structure in which this sort of display pixels PXi are two-dimensionally arranged in the whole area of the display area Rpx and thereby the lower electrodes 111A (that is, negative electrodes), on which the negative voltage is applied, and the lower electrodes 111B (that is positive electrodes), on which the positive voltage is applied, are alternately arranged.

The principle of operation of the display apparatus having this sort of device structure is equal to that of the aforesaid first embodiment (see FIGS. 4A and 4B), the luminous operations of the luminous pixels PXAe and PXBe (luminous elements EAel and EBel) are performed in the state of applying the predetermined voltages to the upper electrode 113 and the lower electrodes 111A and 111B, and thereby predetermined electric fields (aforesaid first electric field and second electric field) are generated between the upper electrode 113 and the photoconductive layer 112 (lower electrodes 111A and 111B). Furthermore, the black particles 115T and the white particles 115W move as if they are drawn nearer to any of the electrodes according to the electric fields, and consequently the areas (display pixels PXi) displayed in black display and white display are formed in the display area Rpx. Thus desired information is displayed.

Incidentally the aforesaid display apparatus according to the first embodiment and the second embodiment cab be schematically produced by forming the photoconductive layer 112 on the lower electrode 111 common to each of the display pixel PXi and the lower electrodes 111A and 111B divided every display pixel PXi, respectively, by coating the photoconductive layer 112; after that, by putting the electrifiable black particles and white particles between the lower electrodes 11 or 111A and 111B and the upper electrode 113 formed on a transparent substrate 114 commonly to each of the display pixels PXi in the state of being mixed and dispersed; and next by pasting the array substrate 210, on which the luminous pixels PXe (luminous elements Eel) are formed to be arranged in a matrix, together with the under surfaces of the lower electrodes 111, or 111A and 111B in the state of adhering closely to the under surfaces.

### (Drive Method of Display Apparatus)

Next, a drive method of the display apparatus according to the present embodiment will be described Here the display drive operation peculiar to the present embodiment will be described, and the other operations will be suitably referred to those of the first embodiment mentioned above.

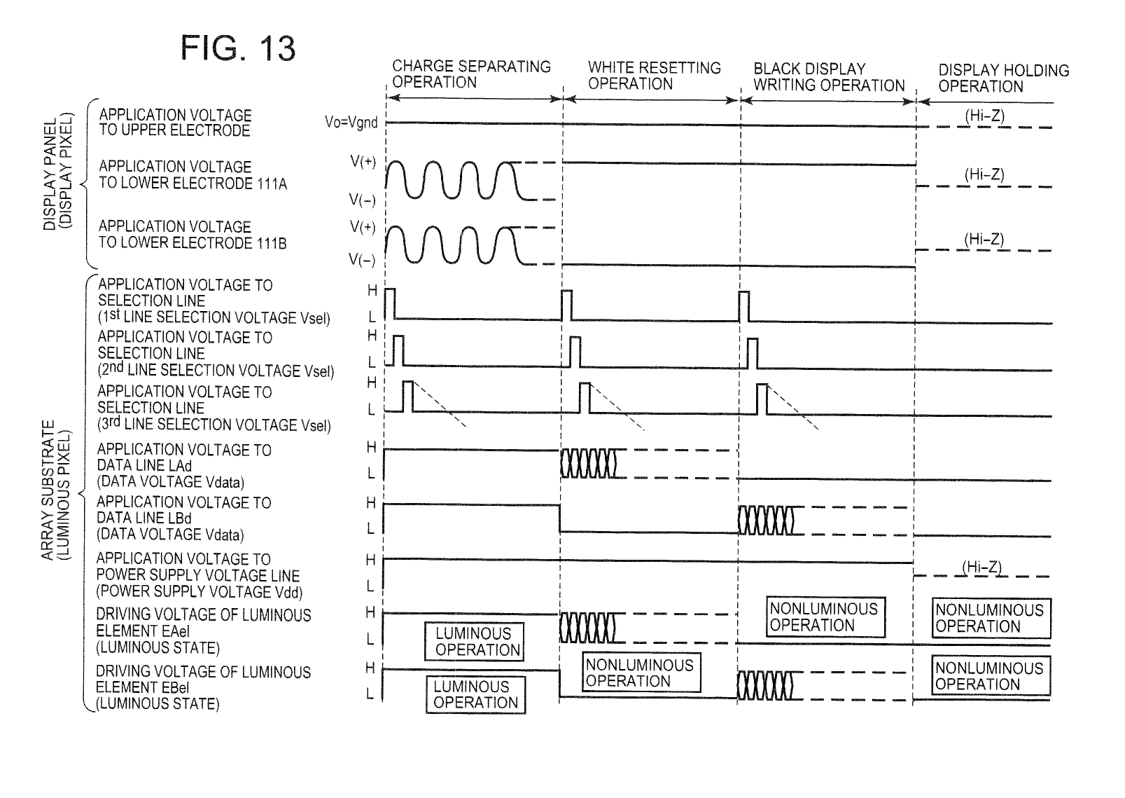

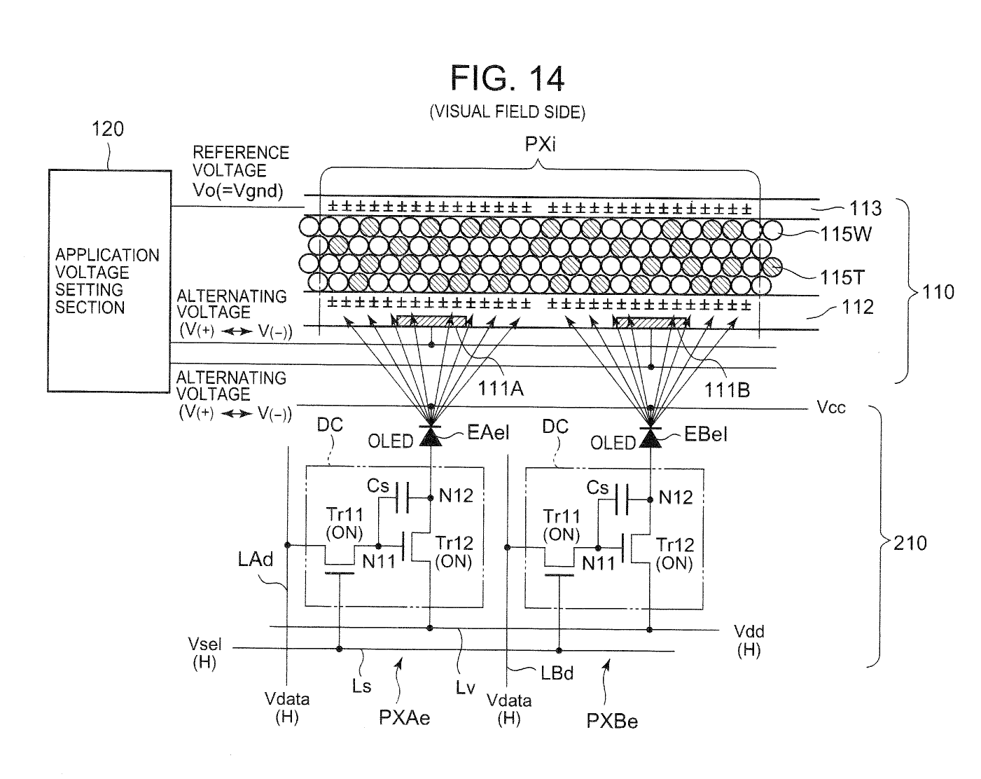

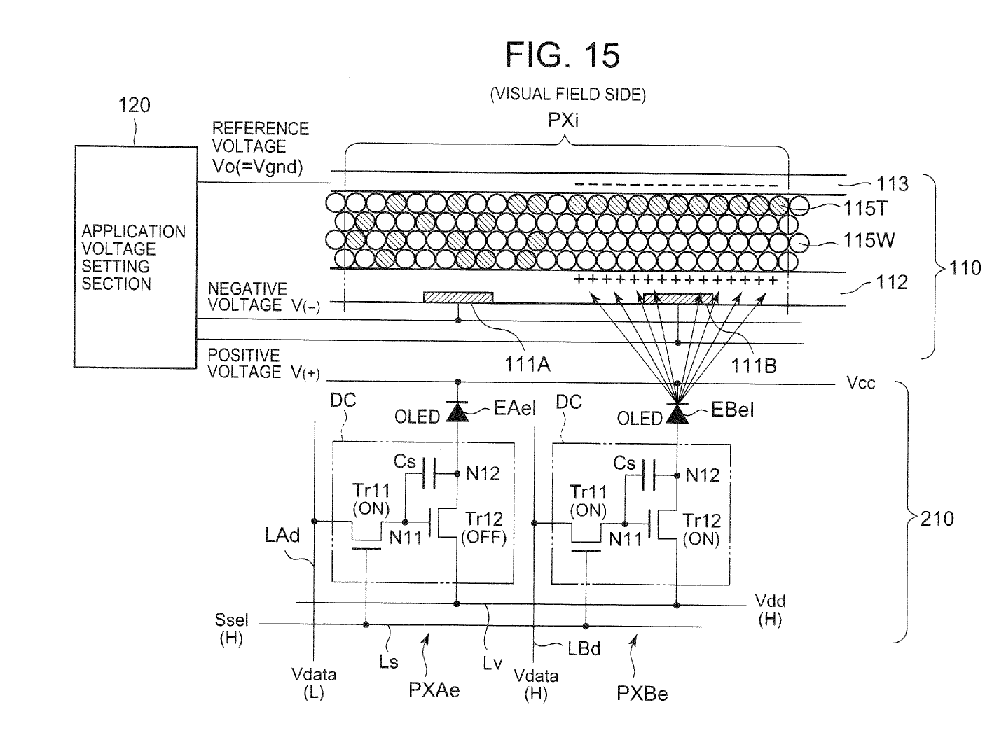

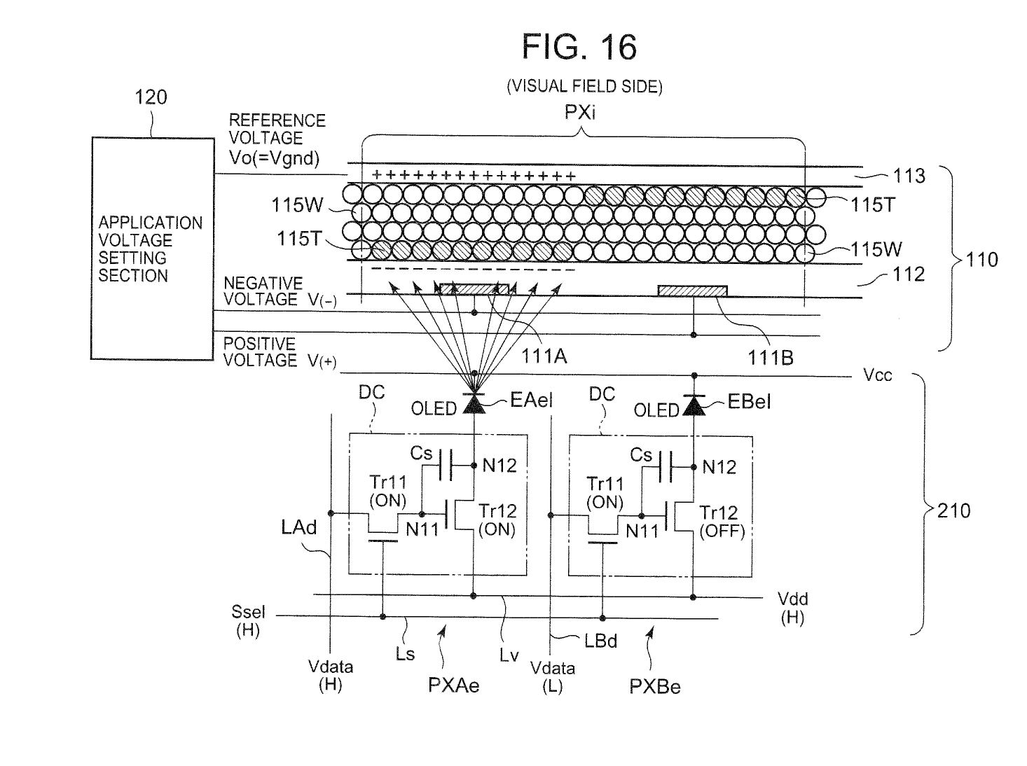

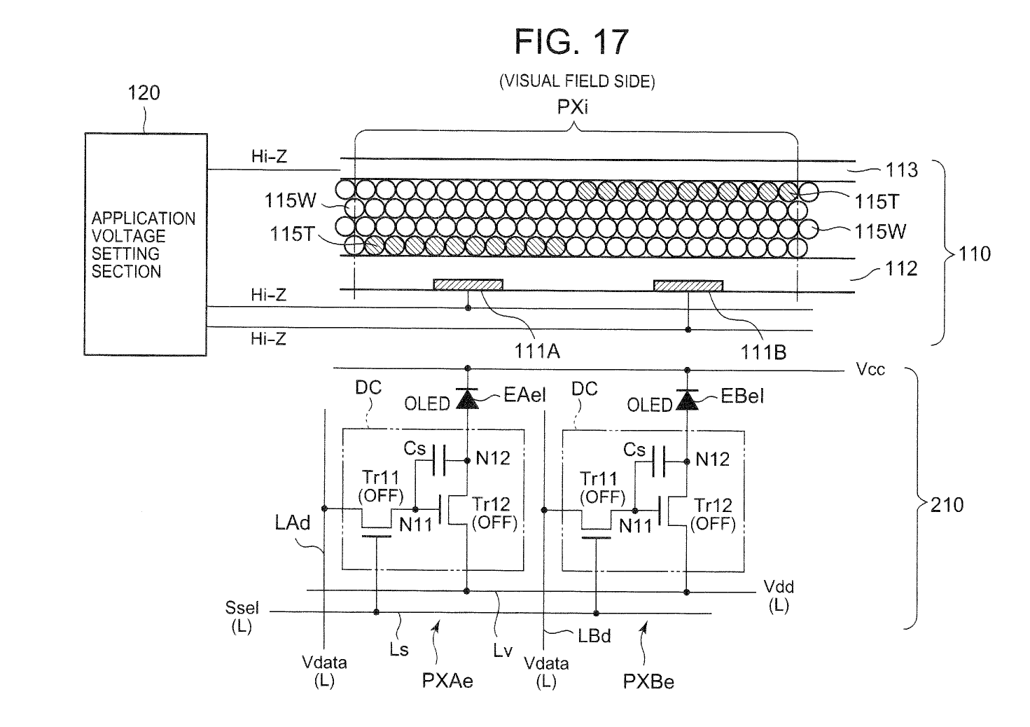

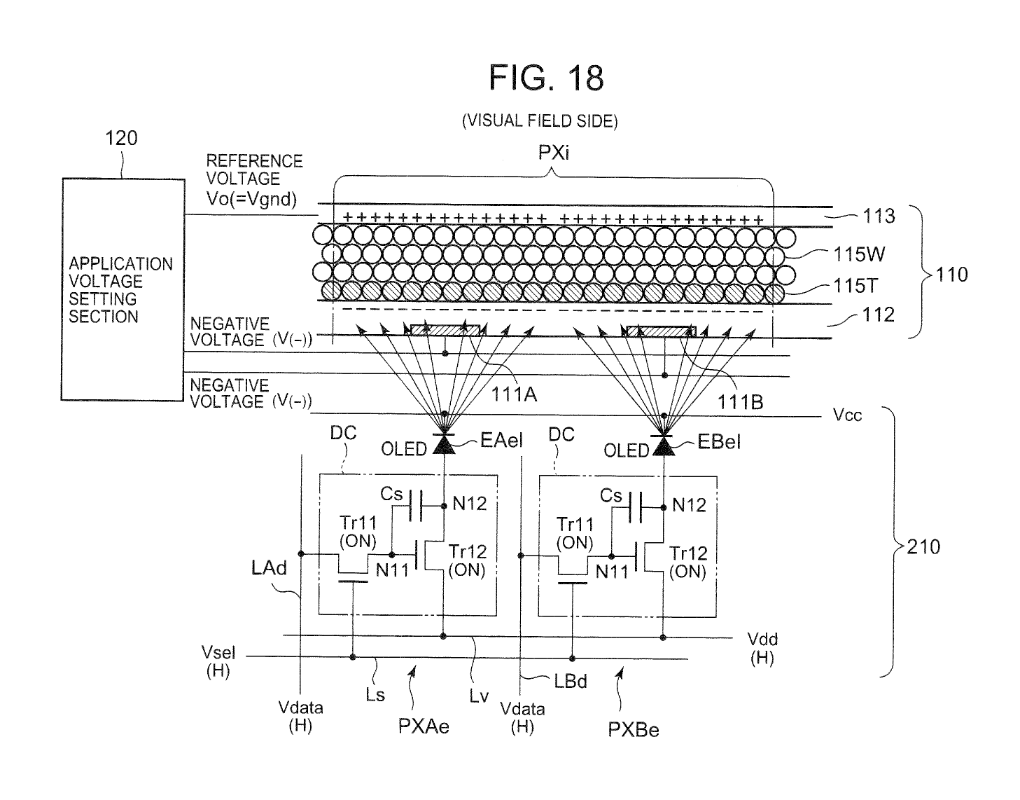

FIG. 13 is a timing chart showing an example of the display drive operation (drive method) of the display apparatus according to the present embodiment. Moreover, FIG. 14 is a schematic state diagram showing the charge separating operation in the display drive operation according to the present embodiment; FIG. 15 is a schematic state diagram showing the black display writing operation in the display drive operation according to the present embodiment; FIG. 16 is a schematic state diagram showing the white display writing operation in the display drive operation according to the present embodiment; and FIG. 17 is a schematic state diagram showing the display holding operation in the display drive operation according to the present embodiment. FIG. 18 is a schematic state diagram showing the white resetting operation in the display drive operation according to the present embodiment.

As shown in FIG. 13, the drive method of the display apparatus according to the present embodiment sequentially executes the charge separating operation, the black display writing operation, and the white display writing operation in a predetermined display operation period, following which the drive method executes the writing holding operation. The charge separating operation applies an alternating electric field between the lower electrodes 111A and 111B (photoconductive layer 112) and the upper electrode 113 to give different electric charges to the respective white particles 115W and the black particles 115T. The black display writing operation performs writing in the areas (display pixels) to be black displays based on display data. The white display writing operation performs writing in the areas (display pixels) to be white displays. The writing holding operation holds the image information (that is the white display states and the black display states) written in the display area Rpx. That is, the present embodiment is controlled to sequentially execute the operation of setting only the areas (display pixels) corresponding to the image information to be displayed to the black display states on the basis of the display data and setting the other areas (display pixels) to be displayed to the white display states to the display area Rpx in the display panel 110 every display pixel two-dimensionally arranged into the row directions and column directions of the display area Rpx (that is, the area corresponding to each of the luminous pixels PXe two-dimensionally arranged on the array substrate 210) or every row.

### (Charge Separating Operation)

First, in the charge separating operation, similarly to the first embodiment (see FIG. 8) mentioned above, as shown in FIG. 14, the reference voltage V0 is applied to the upper electrode 113 of the display panel 110, and alternating voltages to alternately take positive electric potential and negative electric potential to the reference voltage V0 are applied to the lower electrodes 111A and 111B. In this state, all of the luminous pixels PXAe (organic EL elements OLED including luminous elements EAel to which the data voltage Vdata of the white display is supplied through data lines LAd) and PXBe (organic EL elements OLED including luminous elements EBel to which the data voltage Vdata of the black display is supplied through data lines LBd) arranged on the array substrate 210 are made to perform a luminous operation. Thereby, positive charges (+) and negative charges (−) are alternately generated on the surface of the photoconductive layer 112. Thus, an alternating electric field is formed between the photoconductive layer 112 and the upper electrode 113. Thereby, the white particles 115W and the black particles 115T are stirred according to the directions of the electric field to be rubbed against each other. Thus, the white particles 115W are charged to be negative charges and the black particles 115T are charged to be positive charges (charge separation).

### (Black Display Writing Operation)

Next, in the black display writing operation, as shown in FIG. 15, the reference voltage V0 is applied to the upper electrode 113 of the display panel 110. A voltage V(−) of negative electric potential to the reference voltage V0 is applied to the lower electrodes 111A, and a voltage V(+) of positive electric potential to the reference voltage V0 is applied to the lower electrodes 111B. In this state, image information (black display information) is written in the luminous elements EBel dedicated for black display among the display pixels PXi on the basis of display data. By performing the luminous operations of only of the luminous pixels PXBe (luminous elements EBel and organic EL elements OLED) formed on the array substrate 210 correspondingly to the lower electrodes 111B to which the positive voltage V(+) is applied, positive charges (+) are generated in the areas of the surface of the photoconductive layer 112 corresponding to the lower electrodes 111B, and negative charges (−) are generated on the surface of the upper electrode 113. Thereby, the first electric field mentioned above (see FIGS. 4A and 4B) is generated, and the black particles 115T are moved to the side of the upper electrode 113 to be set in the black display states. At this time, the luminous pixels PXAe (luminous elements EAel and organic EL Elements OLED) formed on the array substrate 210 correspondingly to the lower electrodes 111A, to which the negative voltage V(−) is applied, of the display pixels PXi are set to non-luminous states, and thereby no electric fields are generated between the areas of the photoconductive layer 112 corresponding to the lower electrodes 111A and the upper electrode 113. Thus, the aforesaid charge separation state is held.

### (White Display Writing Operation)

Next, in the white display writing operation, similarly to the black display writing operation mentioned above, as shown in FIG. 16, the reference voltage V0 is applied to the upper electrode 113 of the display panel 110. A voltage V(−) of negative electric potential to the reference voltage V0 is applied to the lower electrodes 111A, and a voltage V(+) of positive electric potential to the reference voltage V0 is applied to the lower electrodes 111B. In this state, image information (white display information) is written in the luminous elements EAel dedicated for white display among the display pixels PXi on the basis of display data. By performing the luminous operations of the luminous pixels PXAe (luminous elements EAel and organic EL elements OLED) formed on the array substrate 210 correspondingly to the lower electrodes 111A to which the negative voltage V(−) is applied, negative charges (−) are generated in the areas of the surface of the photoconductive layer 112 corresponding to the lower electrodes 111A, and positive charges (+) are generated on the surface of the upper electrode 113 to form the second electric field mentioned above (see FIGS. 4A and 4B). Thereby, the black particles 115T are moved to the side of the photoconductive layer 112 (lower electrodes 111A) to be set in the white display states. At this time, the luminous pixels PXBe (luminous elements EBel and organic EL Elements OLED) formed on the array substrate 210 correspondingly to the lower electrodes 111B, to which the positive voltage V(+) is applied, of the display pixels PXi are set to non-luminous states, and thereby no electric fields are generated between the areas of the photoconductive layer 112 corresponding to the lower electrodes 111B and the upper electrode 113. Thus, the aforesaid charge separation state is held.

Incidentally, the white display operation may be the one of setting also the display pixels PXi in which image information has been written on the basis of the display data in the black display operation mentioned above (has been set in the black display state) to the white display state by moving the black particles 115T in the area to the photoconductive layer 112 (lower electrodes 111A) by forming the second electric field (see FIGS. 4A and 4E) between the area of the photoconductive layer 112 corresponding to the lower electrodes 111A and the upper electrode 113 by performing the luminous operations of the luminous pixels PXAe (luminous elements EAel and organic EL elements OLED) formed on the array substrate 210 correspondingly to the lower electrodes 111A, to which the negative voltage V(−) is applied. Moreover, in place of dividing the luminous elements into the luminous elements EAel dedicated for white display and the luminous elements EBel dedicated for black display, all of the luminous elements may be the ones capable of selecting both of the white display and the black display. In this case, if one of the luminous elements emits a light in a white display operation period, then the display pixel PXi corresponding to the luminous element performs the white display. If the luminous element emits a light in a black display operation period, then the display pixel PXi performs the black display.

### (Display Holding Operation)

Next, in the display holding operation, similarly to that of the first embodiment (see FIG. 11), as shown in FIG. 17, after the completion of the aforesaid black display writing operation and the white display operation, the application of the voltages to the lower electrodes 111A and 111B and the upper electrode 113 of the display panel 110 is blocked to set them to be in high impedance states, and each of the luminous pixels PXAe and PXBe in the array substrate 210 (luminous area Rel) is set to the non-luminous state. Thereby written image information is held.

As described above, also by the display apparatus and the drive control method thereof according to the present embodiment, a predetermined electric field can be generated between the upper electrode and each of the lower electrodes (photoconductive layer) by applying predetermined voltages between the upper electrode and the lower electrodes of the display panel according to display data and by making predetermined luminous pixels (luminous elements) in the array substrate emit lights without using any dedicated display drivers and display switching elements (such as transistors) having high withstand voltages. Then, the black particles and the white particles can be moved to either electrode side of the upper electrode on the visual field side and the lower electrodes, and desired image information can be displayed.

Incidentally, since the present embodiment has the panel structure to realize the white display state on the side of the lower electrode 111A and the black display state on the side of the lower electrode 111B between the lower electrodes 111A and 111B formed in each of the display pixels PXi of the display panel 110, the present embodiment has the possibility of damaging the visual quality of the white ground (background), which is a feature of the display apparatus having the electric paper structure, owing to the remaining of the area in which the charge separation state is being held and the areas of the display pixels PXi that have not been rewritten when, for example, the areas have been rewritten from the black display state to the white display state (or the case of the reverse thereof).

Accordingly, in such a case, image information (black display information) may be written by executing the black display writing operation mentioned above after setting the whole area of the display area Rpx to the white display state by executing the white resetting operation in advance as shown in FIG. 18 at the time of rewriting the image information. Here the white resetting operation shown in FIG. 18 is executed as follows similarly to that of the first embodiment mentioned above: applying the reference voltage V0 to the upper electrode 113 of the display panel 110 (or blocking the application of the reference voltage V0 to the upper electrode 113); applying the voltage V(−) of the negative electric potential to the reference voltage V0 to the lower electrodes 111A and 111B; in this state, performing the luminous operations of all of the luminous pixels PXAe (luminous elements EAel) and PXBe (luminous elements EBel) arranged on the array substrate 210; thereby generating the negative charges (−) on the surface of the photoconductive layer 112; forming the second electric field (see FIGS. 4A and 4B) between the photoconductive layer 112 and the upper electrode 113; moving the black particles 115T to the side of the photoconductive layer 112; and thereby setting the whole area of the display area Rpx to the white display state.

### Third Embodiment

Next, a display apparatus and a drive method thereof according to a third embodiment will be described.

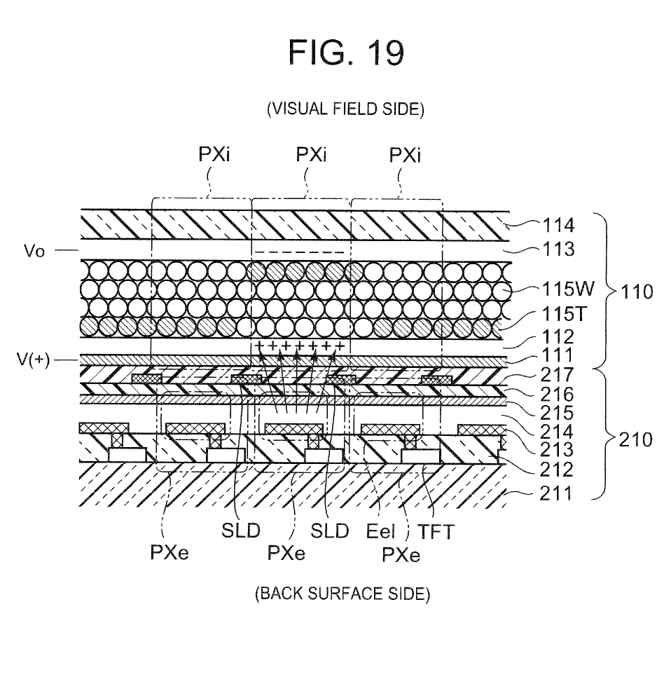

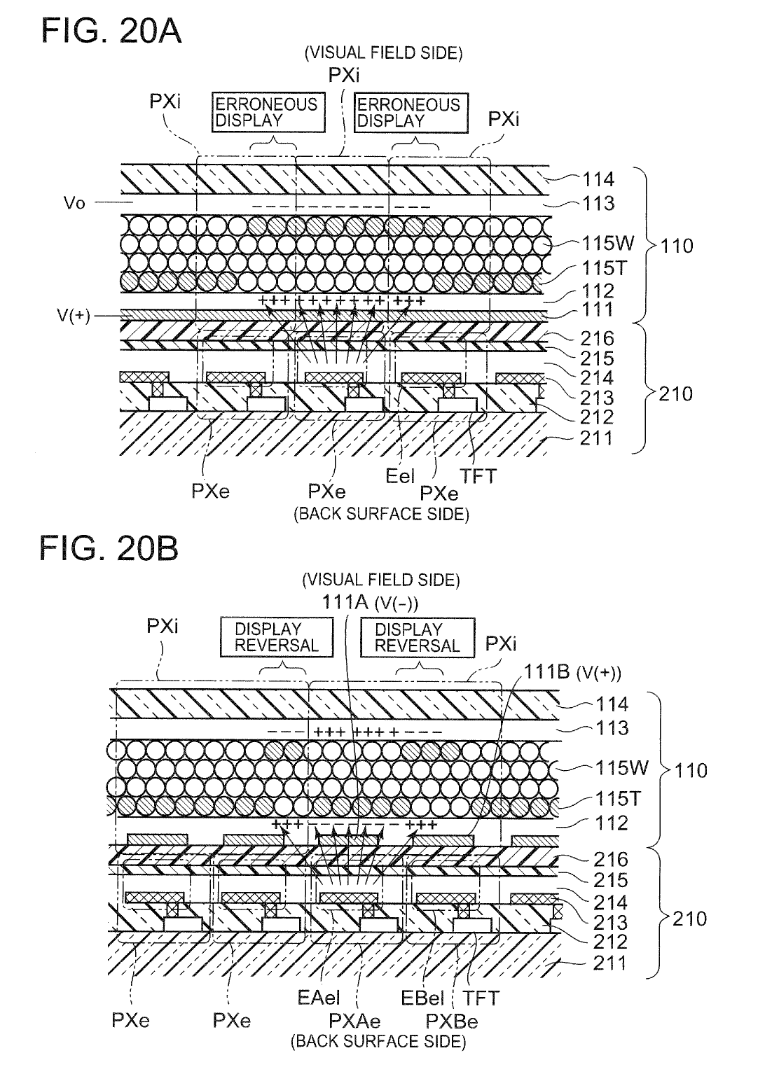

FIG. 19 is a principal part sectional view showing the device structure of the display apparatus according to the third embodiment, and FIGS. 20A and 20B are conceptual diagrams for illustrating a display failure owing to crosstalk arising between adjacent display pixels. Here the case of applying the technical idea of the present embodiment to the device structure of the first embodiment (see FIG. 3) will be described. Accordingly, the configurations equal to those of the first embodiment are denoted by the same marks as those of the first embodiment, and their descriptions are simplified or omitted. Incidentally, parts of the hatchings expressing cross sections are omitted to be shown also in FIG. 19 for convenience of diagrammatic representation.

The display apparatus according to the third embodiment is provided with light blocking films or members between display pixels PXi or between luminous pixels PXe in the device stricter (see FIG. 3) of the first embodiment lest the light should be dispersed to radiate the photoconductive layer 112 of an adjacent display pixel PXi which light has emitted from each of the luminous pixels PXe (luminous elements Eel and organic EL elements OLED) two-dimensionally arranged in the luminous area Rel of the luminous element array section 200 correspondingly to the display pixels PXi set in the display panel 110 of the electric paper display section 100 as shown in FIG. 19.

To put it concretely, light blocking bodies SLD including an opaque film material such as chromium are formed in the boundary areas between luminous pixels PXe on the transparent insulation film 216 to coat the counter electrode 215 formed to be common to the luminous pixels PXe arranged on the array substrate 210. Here the light blocking bodies SLD are not limited to chromium, but may be the ones including a resin material having a lower light transmittance as long as the material has the lower light transmittance. Moreover, the display panel 110 of the electric paper display section 100 is joined to a transparent insulation film 217 including a transparent resin material, such as silicon nitride (SiN) and silicon oxide (SiO₂), so as to adhere closely to the transparent insulation film 217, above the transparent insulation film 216, on which the light blocking bodies SLD are formed.

By the light blocking bodies SLD, as shown in FIG. 19, for example, a light that has emitted from a luminous pixel PXe (luminous element Eel and organic EL element OLED) corresponding to a specific display pixel PXi in which a black display writing operation is executed on the basis of display data and has been dispersed is intercepted by the light blocking bodies SLD, and consequently the irradiation of the photoconductive layer 112 of the display pixel PXi that adjoins the display pixel PXi and is not subjected to any black display writing operations (that is, to be displayed in white display) by the light can be prevented. Consequently, as shown in FIG. 20A, the embodiment can prevent the phenomenon of the irradiation of the photoconductive layer 112 of the adjacent display pixel PXi by a ling emitted form the luminous pixel PXe (luminous element Eel and organic EL element OLED) (that is, crosstalk) to generate an electric field between the photoconductive layer 112 of the display pixel PXi and the upper electrode 113 and to set the adjacent pixel in a black display state, so that an erroneous display and a blur arise. Consequently, the embodiment can realize high quality black display and white display.

Incidentally, the description has been given to the case where the light blocking bodies are formed in the device structure of the first embodiment (see FIG. 3) with reference to FIG. 19 [symbol] , but the present invention is not limited to the configuration. The light blocking bodies may be provided in the device structure of the second embodiment. In this case, as shown in FIG. 20B, the negative voltage V(−) and the positive voltage V(+), which are in mutually reversed phases, are always applied to mutually adjacent lower electrodes 111A and 111B during the periods of a black display writing operation based on display data and white display writing operation. Consequently, a phenomenon in which a light that has been emitted from the luminous pixel PXe corresponding to a specific display pixel PXi and has been dispersed is radiated on the photoconductive layer 112 of an adjacent area to generate an electric field, which reverses the display state of the adjacent area, can be prevented.

Moreover, as for the device structure shown in FIG. 19, the case of providing the light blocking bodies SLD including chromium or the like on the transparent insulation film 216 formed at the uppermost layer of the array substrate 210 has been described, but the device structure is not limited to the shown one. For example, the device structure may be the one in which the light blocking bodies SLD are directly formed on the counter electrode 215 formed to be common to the luminous pixels PXe arranged on the array substrate 210.

### Fourth Embodiment

Next, a display apparatus and a drive method thereof according to a fourth embodiment will be described.

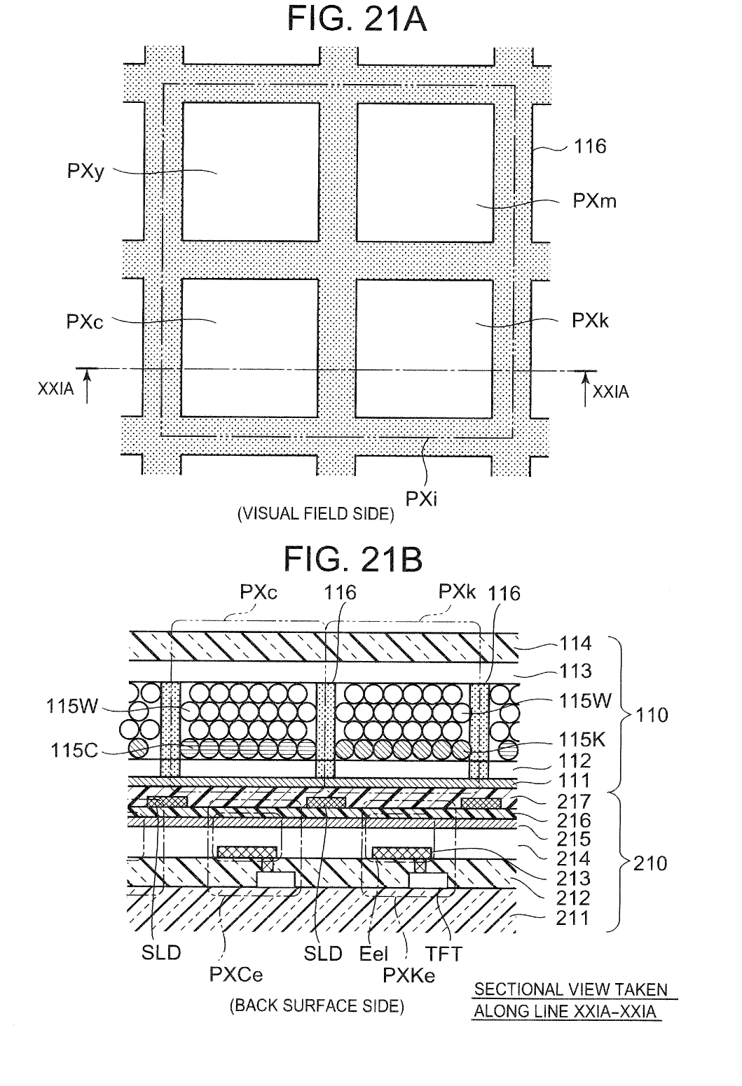

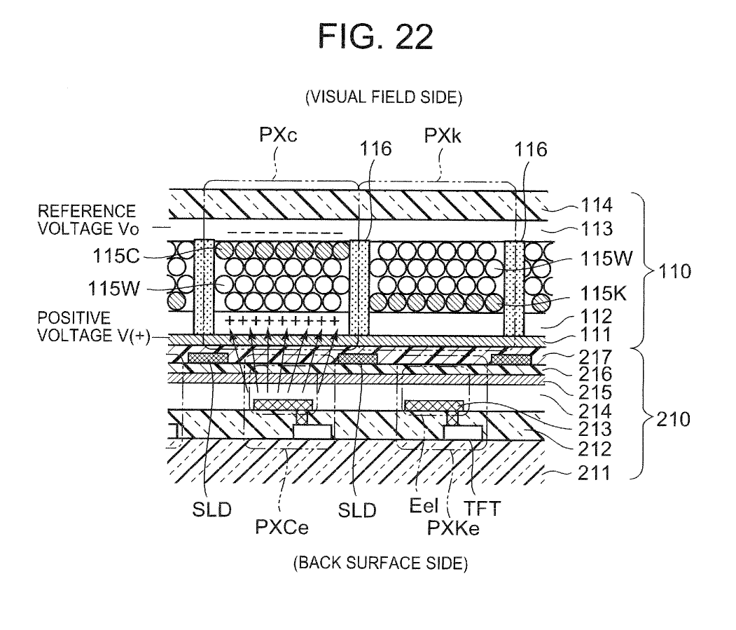

FIGS. 21A and 21B are principal part configuration diagrams showing the display apparatus according to the fourth embodiment. Here FIG. 21A is a principal part plan view showing the display apparatus according to the fourth embodiment, and FIG. 21B is a principal part sectional view showing a cross section taken along a line XXIA-XXIA (“XXI” shown in FIG. 21A is used as a mark corresponding to a Roman numeral “21” in the present description for descriptive purposes) in the principal part plan view shown in FIG. 21A. FIG. 22 is a schematic state diagram showing an example of a color display writing operation in a display drive operation according to the present embodiment. Here description is given to the case where the technical idea of the present embodiment is applied to the device structures shown in the aforesaid first embodiment (see FIG. 3) and the third embodiment (see FIG. 19). Accordingly, the configurations equal to those of the first and third embodiments are denoted by the same marks as those of the first and third embodiments, and their descriptions are simplified or omitted.

Incidentally, also in FIGS. 21A and 21B, a part of the hatchings expressing cross sections are omitted to be shown for convenience of diagrammatic representation.

Each of the aforesaid embodiments has the device structure of putting (sealing) the electrifiable black particles 115T and the white particles 115W in a gap between the photoconductive layer 112 (lower electrode 111) and the upper electrode 113 in the state of being intermixed and dispersed, and the case of performing the monochrome displaying of image information by the white display states and the black display states has been described. A display pixel in the present embodiment is composed of, for example, four color sub pixels of yellow, magenta, cyan, and black, and the present embodiment has a device structure capable of color display of image information by controlling the display state of each color As shown in FIGS. 21A and 21B, the display apparatus according to the present embodiment includes the display pixels PXi two-dimensionally arranged in the display panel 110 of the electric paper display section 100 each of which is composed of sub pixel PXy, PXm, PXc, and PXk of four colors of yellow, magenta, cyan, and black, respectively, which are arranged in a matrix of two rows and two columns. The sub pixel PXy includes yellow-colored particles (toner) and white particles; the sub pixel PXm includes magenta-colored particles and white particles; the sub pixel PXc includes cyan-colored particles and white particles; and the sub pixel PXk includes black-colored particles and white particles The sub pixels PXy, PXm, PXc, and PXk are sealed in the areas each of which is enclosed by a partition wall 116 formed in a grid between the lower electrode 111 (photoconductive layer 112) and the upper electrode 113 in the state of being intermixed and dispersed Here each colored particle of yellow, magenta, cyan, and black has a characteristic to be easily charged to positive (+) similarly to, for example, the aforesaid black particles 115T. On the other hand, the white particles, which are sealed together with those colored particles, have a characteristic to be easily charged to negative (−).

Moreover, the partition walls 116 also have a function of a spacer for regulating the interval between the lower electrode 111 (photoconductive layer 112) and the upper electrode 113. The light blocking bodies SLD for preventing the irradiation of the adjacent areas (sub pixels) of the photoconductive layers 112 by the lights emitted from the luminous pixels (luminous elements) arranged correspondingly to the sub pixels PXy, PXm, PXc, and PXk are provided in the areas on the transparent insulation film 216 formed on the uppermost layer of the arrays substrate 210 of the luminous element array section 200 which areas correspond to the areas in which the partition walls 116 are formed (that is, the boundary areas of the sub pixels).

Incidentally, the display apparatus according to the present embodiment form the partition walls 116 having a desired plane pattern and also functions as a spacer by, for example, the following method: forming the lower electrode 111 common to the respective display pixels PXi on the transparent insulation film 217 at the uppermost layer of the array substrate 210, in which the luminous pixels (luminous elements) having the top emission type luminous structure are formed in a matrix; after that, forming an organic insulation film thereon by a spin coat method or by pasting a dry film; performing the exposure and development processing to form partition walls 116 by a wet process or a dry process. Hereby, the formation area of each sub pixel is defined to be subjected to the partition, and the lower electrode 111 is exposed in the areas (the insides of the areas enclosed by the partition walls 116).

Next, the photoconductive layer 112 is formed by being coated on the lower electrode 111 exposed in the areas in which the sub pixels are formed by means of a vapor deposition method, such as a sputtering method and a chemical vapor deposition (CVD) method, or a wet method, such as the spin coat method, an ink jet printing method, a printing method. Successively an ink in which each colored particles of yellow, magenta, cyan, and black and white particles are mixed with a volatile solvent is prepared, and the prepared ink is applied on the predetermined sub pixels by the ink jet method, the printing method, or the like. After the volatile solvent of the ink has been dried, the transparent substrate 114 on which upper electrode 113 including the transparent electrodes are formed is pasted together with the lower electrode and the partition walls 116 are put between them. Thus the display panel 110 can be produced.

The principle of operation of the display apparatus having such a device structure is equal to that of the aforesaid first embodiment (see FIGS. 4A and 4B), and the principle is as follows: the predetermined voltages are applied to the upper electrode 113 and the lower electrode 111; in this state the luminous operation of the luminous pixels formed on the array substrate 210 corresponding to the each of the sub pixels PXy, PXm, PXc, and PXk according to display data; thereby the predetermined electric fields (first electric field and second electric field) are generated between the upper electrode 113 and the photoconductive layer 112 (lower electrode 111) ; each of the colored particles and the white particles 115W move to any of the electrodes as if the particles are drawn nearer to the electrode; and thus the areas (display pixels PXi) that are subjected to colored display and white display are formed in the display area Rpx, so that desired image information is displayed with colors.

For example, as shown in FIG. 22, the reference voltage V0 is applied to the upper electrode 113, and the positive voltage V(+) is applied to the lower electrode 111 In this state, the luminous operation of a luminous pixel PXCe (luminous elements Eel) formed correspondingly to a cyan sub pixel PXc is performed, and thereby the first electric field is generated between the upper electrode 113 and the photoconductive layer 112 (lower electrode 111). Thereby, the cyan-colored particles 115C move to the side of the upper electrode 113, and thus the cyan-colored particles 115C are sighted from the visual field side to realize the color display. At this time, it is prevented that a light emitted from the luminous pixel PXCe (luminous element Eel) irradiates the photoconductive layer 112 in adjacent sub pixels by the light blocking bodies SLD formed in the boundary areas between the adjacent sub pixels, and consequently the influences of crosstalk shown in FIGS. 20A and 20B to the visual quality can be prevented. On the other hand, in a black sub pixel PXk, a corresponding luminous pixel PXKe (luminous element Eel) is set to its non-luminous state, and consequently no electric fields are generated between the upper electrode 113 and the photoconductive layer 112 (lower electrode 111). Then, for example, the aforesaid charge separation state and the white reset state are held. Thereby, the white particles 115W are sighted from the visual field side to realize the white display.

As described above, in the display apparatus and the drive control method thereof according to the present embodiment, the predetermined voltage is applied between the upper electrode and the lower electrode of the display panel according to display data, and predetermined luminous pixels (luminous elements) in the array substrate are made to emit lights. Thereby, the predetermined electric field can be generated between the upper electrode and the lower electrode (photoconductive layer) without using any dedicated display drivers and display switching elements (such as transistors) having high withstand voltages, and the colored particles and the white particles are moved to either electrode side of the upper electrode of the visual field side and the lower electrode in each of the color sub pixels visual field side. Thus the color display of desired image information can be realized.

Incidentally, a display pixel PXi is divided into four pieces (quadrisection) of the sub pixel PXy, PXm, PXc, and PXk, each having the same area, in the present embodiment, but the division method is not limited to the quadrisection. For example, the division method of making each of the sub pixels PXy, PXm, PXc, PXk have a different area may be adopted, or the division method of dividing a display pixel PXi into an arbitrary number of pieces other than four according to the number of kinds of the colored particles to be sealed in sub pixels may be adopted.

The display apparatus and their drive methods according to the present invention can be applied to electric paper, and can write and display desired image information securely and well without using any dedicated drivers and switching elements having the resistance property to high potential differences.

This application claims the benefit of Japanese Patent Application No. 2007-243775, filed on Sep. 20, 2007, which is hereby incorporated by reference herein in its entirety including the description, claims, attached drawings, the abstract thereof.

While the present invention has been described with reference to various exemplary embodiments, it is to be understood that the invention is not limited to the disclosed exemplary embodiments.

Consequently, the scope of the present invention is limited only by the following claims.

What is claimed is:

1. A display apparatus comprising:
a display section including a display panel having a plurality of arranged display pixels, a display state of each of the display pixels being changed by an electric field generated between a pair of electrodes arranged to be opposed to each other;
a luminous section including a luminous panel having a plurality of luminous pixels arranged correspondingly to each of the plurality of display pixels; and
a control section for controlling the display state of one of the display pixels in the display panel by making an arbitrary one of the luminous pixels in the luminous panel emit a light.

2. The display apparatus according to claim 1, wherein the display panel includes electrifiable particles having charging characteristics of different polarities and different colors, the particles put between the pair of electrodes to be sealed therein.

3. The display apparatus according to claim 1, wherein the display panel includes electrifiable particles having charging characteristics of different polarities and different colors, the particles put between the pair of electrodes to be sealed therein, and the display panel further includes a partition wall to partition a space in which the electrifiable particles are sealed by each of the display pixels.

4. The display apparatus according to claim 1, wherein the pair of electrodes includes a first electrode and a second electrode, and the first electrode of the display panel is coated by a photoconductive layer.

5. The display apparatus according to claim 1, wherein each of the pair of electrodes is composed of a single electrode layer common to the plurality of display pixels.

6. The display apparatus according to claim 1, wherein
the pair of electrodes includes a first electrode and a second electrode, and
the display section further includes an application voltage setting section to apply a predetermined reference voltage to the second electrode, and to apply a voltage of being either of relatively positive electric potential and negative electric potential to the reference voltage to the first electrode.

7. The display apparatus according to claim 1, wherein the luminous panel includes light blocking bodies to block lights emitted from the luminous pixels in boundary areas between any twos of the display pixels.

8. The display apparatus according to claim 1, wherein
the pair of electrodes includes a first electrode and a second electrode;
the first electrode includes a pair of electrode layers divided by each of the display pixels;
the second electrode is composed of a single electrode layer common to the plurality of display pixels; and
the luminous pixels are arranged correspondingly to each of the electrode layers in the luminous panel.

9. The display apparatus according to claim 1, wherein
the pair of electrodes includes a first electrode and a second electrode; and
the display section includes an application voltage setting section to apply a predetermined reference voltage to the second electrode, to apply a voltage of being relatively positive electric potential to the reference voltage to one electrode layer of the first electrode, and to apply a voltage of being relatively negative electric potential to the reference voltage to another electrode layer of the first electrode.

10. The display apparatus according to claim 1, wherein the plurality of luminous pixels is two-dimensionally arranged in the luminous panel, each of the luminous pixels including an organic electroluminescence element having a top emission type luminous structure.

11. A drive method of a display apparatus comprising a display section including a display panel having a plurality of arranged display pixels, a display state of each of the display pixels being changed by an electric field generated between a pair of electrodes to include a first electrode and a second electrode arranged to be opposed to each other, and a luminous section including a luminous panel having a plurality of luminous pixels arranged correspondingly to each of the plurality of display pixels, the method comprising the step of:
making an arbitrary one of the luminous pixels in the luminous panel emits a light;
generating the electric field between the first electrode and the second electrode of the display panel; and
controlling the display state of one of the display pixels to display desired image information.

12. The drive method of a display apparatus according to claim 11, wherein
the step of generating the electric field between the first electrode and the second electrode is performed by making an arbitrary one of the luminous pixels in the luminous panel emit a light in a state of applying a predetermined reference voltage to the second electrode and applying a voltage of being either of relatively positive electric potential and negative electric potential to the reference voltage to the first electrode.

13. The drive method of a display apparatus according to claim 11, further comprising the steps of:
executing a reset operation to set all the display pixels in a first display state by making all the luminous pixels in the luminous panel emit lights in a state of applying a predetermined reference voltage to the second electrode and applying a first voltage of being either of relatively positive electric potential and negative electric potential to the reference voltage to the first electrode; and
executing a display writing operation to set an arbitrary one of the display pixels in a second display state by making an arbitrary one of the luminous pixels in the luminous panel emit a light in a state of applying the reference voltage to the second electrode and applying a second voltage of being either of the negative electric potential and the positive electric potential to the reference voltage to the first electrode.

14. The drive method of a display apparatus according to claim 13, further comprising the step of executing a charge separating operation to charge electrifiable particles having different colors, the particles sealed between the first electrode and the second electrode of the display panel, by generating an alternating electric field between the first electrode and the second electrode by making all the luminous pixels in the luminous panel emit lights in a state of applying the reference voltage to the second electrode and applying an alternating voltage of periodically changing to be the positive electric potential and the negative electric potential to the reference voltage to the first electrode, prior to either of the reset operation and the display writing operation.
